(19) United States
(12) Patent Application Publication
(10) Pub. No.: US 2012/0114809 A1
(43) Pub. Date: May 10, 2012

(54) DELIVERING AEROSOLIZABLE FOOD PRODUCTS

(76) Inventors: David A. Edwards, Boston, MA (US); Jonathan Man, Bellevue, WA (US); Jonathan Jacques Kamler, Jamaica, NY (US); Jose Sanchez, Paris (FR); Marc Bretillot, Paris (FR)

(21) Appl. No.: 13/132,469

(22) PCT Filed: Dec. 3, 2009
(86) PCT No.: PCT/US2009/066590

§ 371 Date: Jan. 23, 2012

Related U.S. Application Data
(60) Provisional application No. 61/200,716, filed on Dec. 3, 2008.
(60) Provisional application No. 61/177,466, filed on May 12, 2009.

(51) Int. Cl. B65D 83/14; A23P 1/16

(52) U.S. Cl. 426/116; 426/106; 222/635

(57) ABSTRACT

Aerosolized food products in a determined particle size range are suspended in the air and deposited in the mouth without easily entering into the respiratory tract. An apparatus incorporating an aerosol generating device and food products can allow for the aerosolization of the food products and the delivery thereof in a manner suitable for inhalation or deposition and subsequent ingestion. The food delivery apparatus represents a novel means for delivering food to the mouths of humans and animals. Indeed, the apparatus of the invention is designed to produce, transport, and direct aerosolized food particles in a determined size range, suspended in air, to be deposited in the mouth without substantial exposure or entry into the respiratory tract.

### FIELD OF THE INVENTION

The invention relates generally to aerosolized food products and apparatus for the containment, aerosolization, and/or delivery thereof.

### BACKGROUND

Previous researchers have demonstrated that aerosol particles can be used to deliver substances to various parts of the body. Certain designs have been proposed for utilizing these particles for drug delivery.

### SUMMARY

When inhaling particles that are sufficiently light to enter the mouth, one must address the risk of those particles reaching the back of the mouth or lungs and causing coughing or other adverse events, especially when the goal is, for example, to provide taste, and/or nourishment, involving the mouth, tongue, etc.

Therefore, approaches to deliver materials to the mouth via the airborne route have largely (if not exclusively) focused on directed, non-breath-actuated delivery, where the force of the air current and size of the particles are such that particle trajectories are primarily limited to within the mouth.

We have developed an approach by which a casual or forced breathing maneuver (such as normal inhalation) can lead to the delivery of food, drink, and/or various other particles to the mouth, in which the transport of these particles with the flowing air, to the back of the throat and to the lungs, is limited. By controlling the inertia and gravity of the food particles, and by directing deposition forces, we can focus delivery of the particles towards surfaces of the mouth, not reaching the back of the throat and lungs.

There are 2 practical aspects to our approach:
1. Particle size is extremely important to our delivery system, namely that the particles need to be small enough to remain airborne during casual breathing, but large enough to be directed and deposited primarily in the mouth while limiting throat and lung deposition.
2. At the same time, typical pathways of aerosol particles through the device and out of the mouthpiece are directed to varying degrees away from the back of the throat.

The combination of appropriate particle size and device-directed air pathway leads to the food particles being deposited primarily in the mouth (and onto the tongue, palate, etc.) rather than at the back of the throat or further into the respiratory tract

In one aspect, a food delivery apparatus includes: an aerosol delivery device (which may also be an aerosol generating device) for discharge of an aerosolized food product generally along a substantially vertical axis; a container attached to the aerosol delivery device. The container defines: a primary chamber hydraulically connected to the aerosol delivery device such that vertical axis along which the delivery device discharges food particles extends into the primary chamber and particles of at least a first size tend to rise and fall along the substantially vertical axis; and a secondary chamber adjacent and open to and/or in communication with the primary chamber, the secondary chamber extending horizontally outward from the primary chamber such that particles smaller than the first size tend to disperse from the primary chamber into the secondary chamber, the secondary chamber having an outlet spaced apart from the primary chamber.

Embodiments can include one or more of the following features, alone or in combination.

In some embodiments, the aerosol delivery device comprises a fluid reservoir with an ultrasonic generator. In some embodiments, the aerosol delivery device comprises a piezo-electric device. In some cases, a free surface of fluid in the fluid reservoir is exposed to the primary chamber of the container.

In some embodiments, a lower surface of the secondary chamber is angled such that liquid landing on the lower surface of the secondary chamber tends to flow towards the fluid reservoir.

Surfaces of the primary chamber can include a surface extending across the substantially vertical axis to limit travel of particles traveling along the substantially vertical axis.

The apparatus can be a tabletop or freestanding unit including a base configured to stably support the container on a supporting surface.

The container can define an aperture extending through the container to the interior cavity, the aperture vertically offset from the aerosol delivery device when the food delivery apparatus is positioned for operation. In some cases, the container defines an aperture opening into and/or communicating with the secondary chamber from above. In some cases, the container comprises a closeable outlet disposed in a lateral side surface of the container.

In some embodiments, the closeable side outlet can include an aperture and a cap biased to close the aperture. In some cases, the apparatus includes a resilient member placed to bias the cap to cover the aperture. In some cases, weight of the cap biases the cap to cover the aperture.

In one aspect, a food delivery apparatus includes: an aerosol delivery device for discharge of aerosolized food product. The aerosol delivery device includes: a mouthpiece defining a first fluid flow passage extending between a mouthpiece inlet and a mouthpiece outlet; a deflection member spaced apart from a plane of the mouthpiece outlet, the deflection member positioned to oppose flow of aerosolized food product along an axis of the mouthpiece outlet; a capsule containing an aerosolizable food product, the capsule defining a second fluid flow passage extending between a capsule inlet and a capsule outlet, the capsule attached to the mouthpiece such that, in a first position of the mouthpiece, the mouthpiece substantially seals the capsule outlet, and, in a second position of the mouthpiece, the capsule outlet is fluidly connected to the mouthpiece inlet; and an end cap defining at least one air intake passage extending through the end cap, the end cap attached to the capsule such that, in a first position of the end cap, the end cap substantially seals the capsule inlet, and, in a second position of the end cap, the capsule inlet is fluidly connected to the air intake passage of the end cap.

Embodiments can include one or more of the following features, alone or in combination.

In some embodiments, the capsule comprises an aerosol generating device. In some cases, the aerosol generating device comprises a grating.

In some embodiments, the capsule is configured to be replaceable.

In some embodiments, the apparatus is configured to be multi-dose.

In some embodiments, the apparatus is configured to provide permanent attachment of the end cap and the mouthpiece to the capsule.

In some embodiments, the apparatus is handheld.

In one aspect, the disclosure is directed to delivery of aerosolized food particles of sufficient size to primarily deposit in the mouth with limited entry into the respiratory tract and of small enough size so as to allow for suspension in air. In another aspect, the disclosure is directed to an apparatus incorporating food products, an aerosol generating device to cause aerosolization of the food products, and a delivery device that delivers the aerosolized food products in a matter suitable for inhalation or deposition and subsequent ingestion. In another aspect, the disclosure is directed to airflow-directing elements in an apparatus or device for the delivery of food products by aerosol. These elements, by controlling gravity, inertia, and other forces relevant to the aerosol cloud upon delivery of the cloud to the mouth, substantially divert the aerosol cloud to surfaces in the mouth and decrease the extent to which the cloud can continue to the throat and further into the respiratory tract.

Our apparatus represents a novel means for delivering food to the mouths of humans and animals. Indeed, the apparatus is designed to produce aerosolized food particles of sufficient size to be deposited in the mouth without substantial exposure or entry into the respiratory tract and of small enough size so as to allow for suspension in air.

In some embodiments, our apparatus generates an aerosol cloud of food particles that enters the mouth of humans or animals by inhalation, bodily movement, and/or aerosol movement, or a combination thereof, in a manner distinct from conventional means of mechanical delivery, i.e., the use of utensils, and conventional means of mechanical digestion of food, i.e., by chewing or sucking. For example, simple inhalation may serve to cause the food particles to be deposited within the digestive tract including the mouth of a subject.

Alternatively or in combination, a subject may physically expose themselves to the food particles released from the apparatus by a simple bodily movement, such as walking or leaning such that the subject's mouth is exposed to the food particles thereby leading to food deposition in the mouth. Alternatively, or in combination, a subject may physically expose themselves to the food particles released from the apparatus by a simple aerosol movement, such as an air current carrying the aerosol, or released from a small container in which a user carries the aerosol, such that the subject's mouth is exposed to the food particles thereby leading to food deposition in the mouth.

Our apparatus generally includes food product and an aerosol generating device. In some embodiments, the apparatus includes food product, an aerosol generating device, and an air intake passage. In some embodiments, the apparatus includes a mouthpiece. In some embodiments, the apparatus consists solely of a mouthpiece. The apparatus may be activated by inhalation at the mouthpiece, thereby resulting in the exposure of the food product to the aerosol generating device and the subsequent aerosolization of the food product. The inhalation further serves to deliver the aerosolized food product to the mouth of the subject.

In some embodiments, the apparatus includes food product, an aerosol generating device, and a force generating device, for example, an air pump. The apparatus may be activated by way of the force generating device, thereby resulting in the exposure of the food product to the aerosol generating device, the subsequent aerosolization of the food product and the emission thereof from the device.

In some embodiments, the apparatus includes food product and an aerosol generating device, for example, an ultrasound source. The apparatus may be activated by way of the aerosol generating device, which may atomize and/or aerosolize the food product and emit the food product from the device.

In some embodiments, the apparatus may incorporate a delivery device.

Food delivery apparatuses can produce aerosol clouds of edible substances by ultrasonication of liquids. These clouds can be inhaled for ingestion, avoiding the respiratory tract, when particle sizes are sufficiently large and the cloud is inhaled.

Ingestible aerosol clouds can be produced through ultrasonication and/or other means which avoid these problems and present many advantages to an inhaled eating experience. In some embodiments, food delivery devices displace the aerosol cloud laterally relative to the source of the aerosol cloud such that large particles rise and fall over the source while smaller particles, particularly if lateral movement of cloud can occur very near to the surface of the liquid, move by diffusion and convention laterally, escaping the falling large droplets.

Large and intermediate droplets convect laterally fall by gravity, so if a lateral chamber is provided to can contain the cloud, a cloud of fine aerosol particles can be made to be a stable standing cloud. This cloud can be designed to possess particles in the desired mouth delivery range by manipulation of the dimensions of the cloud container and the properties of the liquid, including surface tension of the liquid. Notably, surface tensions lower than ˜73 dynes/cm can be achieved with the use of surfactants that produce excellent standing cloud aerosols. Further, an aperture or faucet can be provide whereby the cloud may be poured into glasses or other receptacles, a convenient and useful way of eating substances by inhalation.

### BRIEF DESCRIPTION OF THE DRAWINGS

The advantages of the disclosure described below, as well as further advantages of the disclosure, can be better understood by reference to the description taken in conjunction with the accompanying figures, in which:

FIGS. 1A and 1B are schematics of an embodiment of a food delivery apparatus, respectively, before use and during use.

FIGS. 2A and 2B are perspective views of a food delivery device.

FIGS. 2C and 2D are, respectively, an exploded perspective view and a cut-away perspective view of the food delivery device of FIGS. 2A and 2B.

FIG. 2E is a cut-away perspective view of the food delivery device of FIGS. 2A and 2B

FIGS. 2F and 2G, respectively are a cross-sectional views of the food delivery device of FIGS. 2A and 2B and of a portion of the food delivery device of FIGS. 2A and 2B.

FIG. 3 is a schematic of a particular embodiment of the food delivery apparatus and a diagram for its use and operation.

FIG. 4 presents multiple views of an exemplary embodiment of a mouthpiece 112.

FIG. 5 presents multiple views of an exemplary embodiment of an end cap 114.

FIG. 6 presents multiple views of an exemplary embodiment of a capsule 116

FIGS. 7A and 7B are schematics of a food delivery apparatus, respectively, before use and during use.

FIG. 8 is a photograph of the aerosolization and release of dehydrated mint particles using a hand-actuated aerosol generating apparatus.

FIGS. 9A-9D are, respectively, a perspective view, a top view, a side view, and a bottom view of a food delivery apparatus.

FIGS. 10A-10D are, respectively, perspective, top, side, and end views of an aerosol generating device.

FIG. 11 includes photographs of a food delivery apparatus at different stages of use.

FIGS. 12A-12G are, respectively, perspective, top, front, back, left side, right side and bottom views of a food delivery apparatus.

FIG. 13 includes photographs of a food delivery apparatus at different stages of use.

FIG. 14 includes a photograph of a food delivery apparatus in use.

FIG. 15 is a graph from a HELOS-RODOS particle size analysis of dried, crushed, and sieved mint leaves.

FIGS. 16 and 17 are photographs of a food delivery device. The food delivery devices include a housing, a mouthpiece formed therewith, an airflow directing element attached therewith via bridges, a capsule having air passageways and grating, and a cap having air passageways and capable of snapping together with both the capsule and the housing. In some embodiments, the grating, here part of the capsule, serves as an aerosol-generating device.

FIG. 18 sets forth the specifications of a particular embodiment of a food delivery apparatus. The food delivery apparatus includes a housing, a mouthpiece formed therewith, an airflow directing element attached therewith via bridges, a capsule having air passageways and grating, and a cap having air passageways and capable of snapping together with both the capsule and the housing.

FIGS. 19A and 19B are, respectively, a perspective view and a cross-sectional view of an embodiment of a food delivery apparatus.

FIGS. 19C-19L are detail views of different portions of the embodiment of the food delivery apparatus shown in FIGS. 19A and 19B.

FIGS. 20A and 20B are perspective views of an embodiment of a food delivery apparatus, respectively, in closed and open positions.

FIGS. 20C-20I are detail views of different portions of the embodiment of the food delivery apparatus shown in FIGS. 20A and 20B.

### DETAILED DESCRIPTION

Our approach is based, at least in part, on the realization of a new form of food and methods and apparatus for the delivery thereof. More specifically, the delivery technology and approach is directed to aerosolized food products and a food delivery method and apparatus designed to generate and deliver such products to a subject. Such devices can deliver food substances into the mouth by aerosol wherein the aerosol cloud is generated and delivered to the mouth through a natural inspiration maneuver and wherein the design of the mouthpiece of the device is such that the airborne food particles are diverted away from the back of the throat to limit entry into the respiratory system.

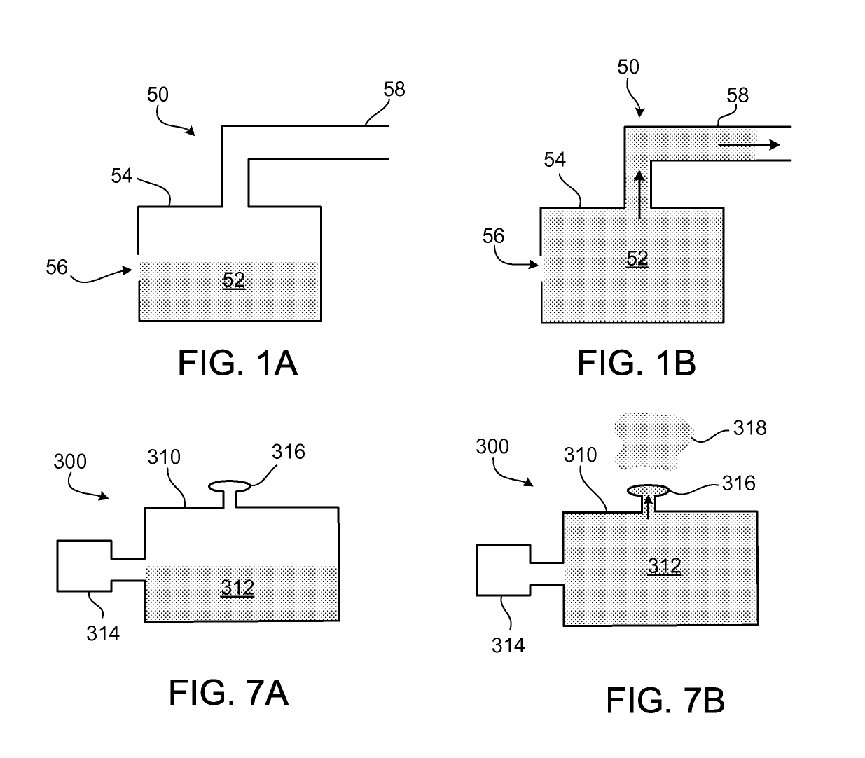

Referring to FIGS. 1A and 1B, a food delivery apparatus 50 includes an aerosol generating device, in which inhalation triggers the aerosolization of a food product 52 and subsequent delivery of the aerosolized food product to the mouth of a subject. The food delivery apparatus 50 includes a compartment 54 containing the food product 52 (e.g., a powdered food). The compartment 54 has an air intake passage 56 and is connected to a mouthpiece 58. The air intake passage 56, the compartment 54, and the mouthpiece 58 allow for the passage of air such that airflow generated by inhalation aerosolizes the food product 52 and transports the aerosolized food product out of the compartment 54, through the mouthpiece 58 and into the consumer's mouth.

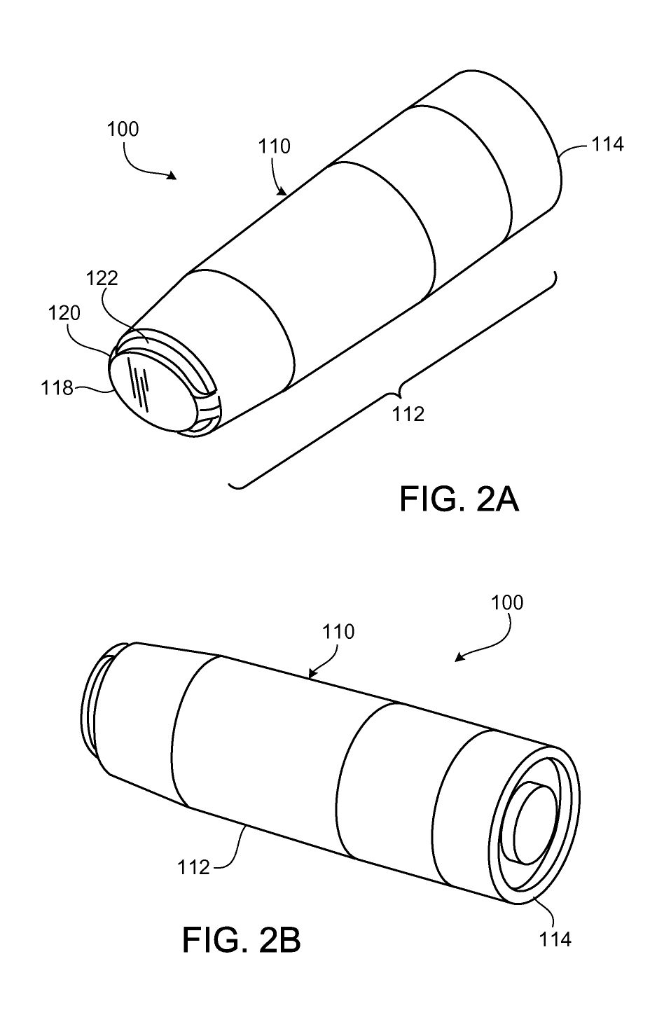

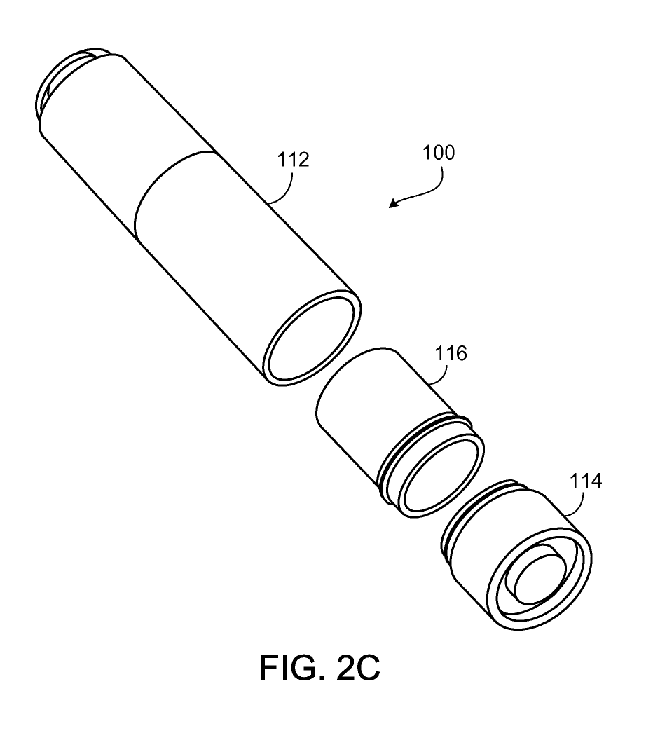

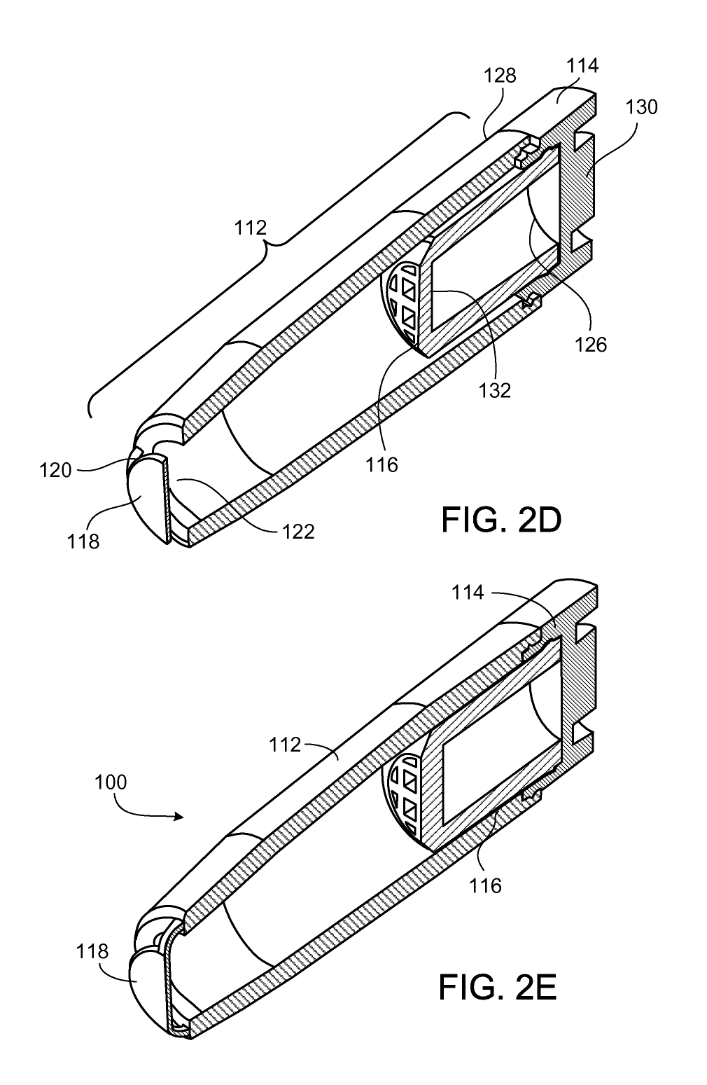

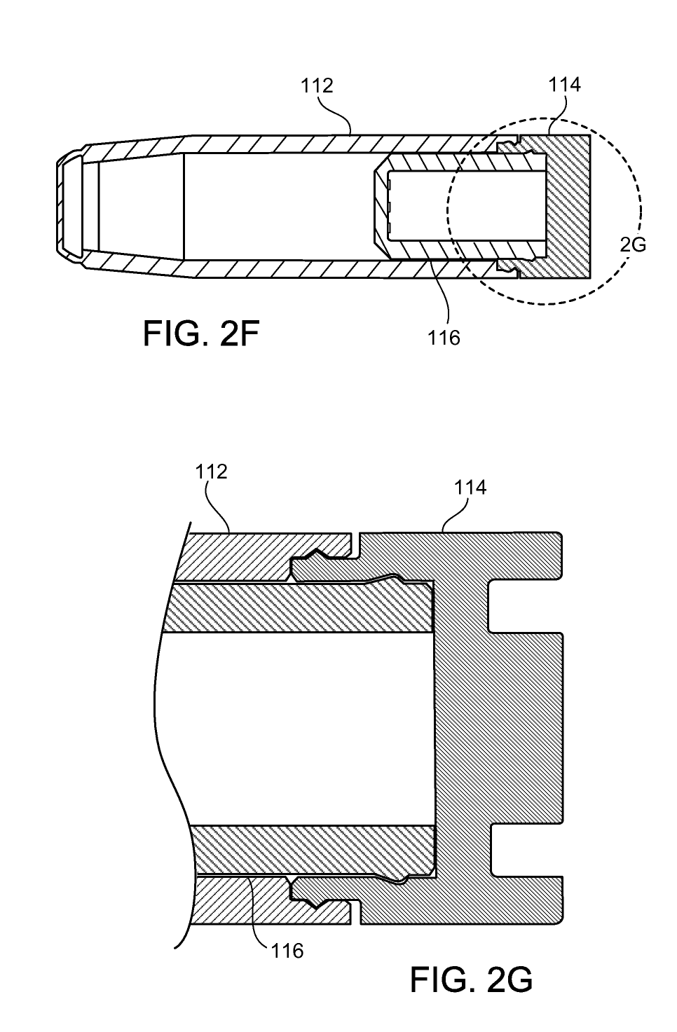

Referring to FIGS. 2A-2F, a food delivery device 100 includes a housing 110 with a mouthpiece 112 and a detachable end cap 114. The food delivery device 100 is sized such that a user can easily hold the device in one hand while using the device 100 to generate and deliver an aerosolized food product. An airflow directing or deflection member 118 is disposed at one end of the mouthpiece 112 with bridges 120. The bridges 120 position the airflow directing member 118 in a location spaced apart from a plane of an outlet 122 of the mouthpiece 112. The end cap 114 is attached to the end of the mouthpiece 112 opposite the airflow directing member 118.

As can be seen in FIG. 2D, the mouthpiece 112 defines a fluid flow passage extending from an inlet 124 to the outlet 122 of the mouthpiece 112. The end cap 114 has air passageways 126 extending from one face of the end cap 114 to an opposite face of the end cap 114. When the end cap 114 is attached to the mouthpiece 112 on the inlet end of the mouthpiece 112, the mouthpiece 112 and the end cap 114 together define a flow path through the housing 110. Thus, when a user places the outlet 122 of the mouthpiece 112 in his or her mouth and inhales, air flows through end cap 114, into the inlet 124 of the mouthpiece 112, and through the mouthpiece 112 to the outlet 122 of the mouthpiece 112. Contact with the airflow directing member 118 deflects the air flowing out of the mouthpiece 112.

In some embodiments, the airflow-directing element and/or deflection member may take any of a variety of forms (not necessarily that of a disc), in order to divert the airflow exiting the mouthpiece and entering the mouth, away from a straight trajectory toward the throat and lungs. For example, there may be one or more openings near the top of a mouthpiece, which may be offset relative to each other, at different heights, of different sizes, of different areas, etc., which maintain the general blockage of the direct linear path toward the back of the mouth, and generally divert the airflow and aerosol such that it goes in more lateral directions.

In some embodiments, the airflow-directing element is a thin disc with a flat surface generally perpendicular to the axis of the mouthpiece and in opposition to the general airflow direction in the mouthpiece. In some cases, the disc may be mounted to the mouthpiece via one or more “bridges”, which may, for example, hold the disc slightly above, below, or at the same level as the edge of the mouthpiece, allowing air, and the aerosolized food product to pass around the disc. In various embodiments, the disc may have a diameter smaller, equal to, or larger than the opening of the mouthpiece. Additionally, the disc may be of any desired shape, for example, an elliptical shape or round shape. The airflow-directing element redirects the aerosol to the sides of the mouth (e.g. top, bottom, left, right surfaces within the mouth), thereby limiting flow of the aerosol toward the throat where it might elicit a coughing reflex. Instead, the aerosolized food product deposits on the tongue or other parts of the mouth where it can be sensed and appreciated rather than carried deeper into the respiratory tract. In some embodiments, the airflow-directing element is of a different shape, size, and/or design but similarly serves to redirect the aerosolized food product so as to limit the coughing reflex and/or to enhance the taste experience. Testing of a variety of disc sizes and positions has shown that these two parameters can impact likelihood of coughing. For example, it was found in preliminary tests that a disc whose diameter is roughly equal to that of the external diameter of the mouthpiece, and that is placed close to the mouthpiece, is generally more effective in redirecting the aerosol and limiting coughing, than one whose diameter is roughly equal to that of the internal diameter of the mouthpiece (thus smaller) and that is placed at a greater distance from the mouthpiece (leaving a larger space for the aerosol to pass through).

In this embodiment, the end cap 114 is formed of a resilient material. A first end 128 of the end cap 114 has an outer surface that is sized and configured to provide a snap-fit engagement with the inner surface of the corresponding end of the mouthpiece 112. In some embodiments, other forms of engagement are used instead of or in addition to snap-fit engagement to attach the end cap 114 to the mouthpiece 112. For example, in some embodiments, the end cap 114 and the mouthpiece 112 have threads and are screwed together.

The mouthpiece 112 together with the end cap 114 (i.e., the housing) define an interior cavity sized to receive a capsule 116 such as, for example, a capsule 116 containing a powdered food product (not shown). The capsule 116 is configured to provide, or otherwise be in, fluid communication between the contents of the capsule 116, for example, a powdered food product, and the mouthpiece. In this embodiment, the capsule 116 has an open end 130 and an opposite aerosol generating end 132. The open end 130 of the capsule 116 fits within the first end 128 of the end cap 114 and is sized and configured to provide a snap-fit engagement with the inner surface of the first end 128 of the end cap 114. In some embodiments, the capsule may be snapped or screwed into the housing. In some embodiments, the capsule includes an open end that may be covered (in certain embodiments, only at certain times) by the cap, for example, by snapping or screwing. In some embodiments, the inlet end of the capsule defines air passages rather being open.

Referring to FIG. 2F, in some embodiments, the capsule 116 snaps into the cap 114 by a full annular snap mechanism on the inside of the cap 114, and the cap 114 snaps into the mouthpiece 112 by an interrupted snap mechanism. The device may thus be designed so that it is typically more difficult to separate the cap 114 from the capsule 116 than to separate the cap 114 and/or capsule 116 from the mouthpiece 112. A user can then easily replace the capsule 116 and/or cap 114 by removing it from the mouthpiece 112, with minimal risk of accidentally detaching the capsule 116 from the cap 114.

Some embodiments may be further enhanced by incorporating snap mechanisms that facilitate the use and functionality of the device. For example, a device may incorporate snap mechanisms to facilitate the use of a mechanism like the one described above that allows for the opening and closing of air passageways. For example, the mouthpiece and capsule can be designed such that they are able to connect by one (or more) snap mechanism(s), and the capsule and cap are able to connect by two (or more) snap mechanism(s). For example, the mouthpiece may be connected to the capsule by one relatively weak snap interface, and the capsule may be connected to the cap by two relatively strong snap interfaces. In some embodiments, these snap mechanisms can: (1) hold the capsule (or, more generally, hold one end of the food-containing apparatus) to the mouthpiece (or, more generally, to the delivery apparatus) (“snap A”); (2) hold the capsule and cap (or, more generally, hold together the components of the food-containing apparatus) in an initial “closed” configuration that minimizes powder loss (especially relevant during shipping, handling, etc.), and may also serve to provide a protected, airtight or nearly airtight environment for the preservation of the food product before use (“snap B”); and (3) after user intervention, reconnect the capsule and cap (or, more generally, the components of the food-containing apparatus) to maintain a new “open” configuration in which air can flow through the apparatus and enable subsequent aerosolization of the food product (“snap C”).

The forces required to actuate each of these snaps plays a role in the functionality and ease of use of the device. They may be configured to allow use as follows: (1) The user attaches the capsule/cap component to the mouthpiece. Snap A is actuated. Now, the capsule is hidden within the mouthpiece and the cap. (2) The user now pulls back on the cap, undoing Snap B. With a strong Snap A, the capsule stays connected to the mouthpiece and the cap slides away from the mouthpiece. This relative motion between the capsule and cap allows for the air passageways to open, as described earlier. (3) The user continues to pull the cap back until Snap C is actuated, locking the capsule and cap in place in such a way as to leave the air passageways open. The user can now inhale and have the food product aerosolize and be delivered to the mouth. Once the food product is consumed, the high strength of this snap (C) allows the user to pull out the capsule/cap from the mouthpiece and replace it with a new capsule/cap, with minimal risk of separating the capsule from the cap instead (the capsule is simultaneously connected to the mouthpiece via snap A and connected to the cap by snap C; since snap C is engineered to be stronger than snap A, a force applied by the user that pulls the mouthpiece and cap in opposite directions generally leads to the capsule and cap detaching from the mouthpiece as one unit, thus undoing snap A). In some embodiments, snap C is also important in that it minimizes the user's ability to completely separate the capsule and cap, even after the mouthpiece is removed. In some cases, it may be desirable to prevent a user from attempting to add his/her own product, or otherwise tamper with the food product or food-containing compartment.

In many instances, variations of some embodiments may be designed without, in many instances, affecting the function of the overall device. For example, the cylindrical nature of the device may be modified, for example, for aesthetic effect, as may the overall length of the device. Alternatively, or in addition, the aerosol generating device, for example, the airflow disrupting element such as a grating, may be incorporated into the cylindrical mouthpiece unit. In some embodiments, the aerosol generating device may include more than one component. For example, a grating and/or the airflow passageways in the cap may play individual roles in generating turbulence that leads to aerosolization, or both may be needed. In general, there may also be multiple configurations of gratings, airflow passageways, dimensions etc, to produce the right aerosolization airflow.

In some embodiments, the dimensions of the device may be selected so that, while preserving the appropriate airflow dynamics, standard medical capsules may be used directly as the compartment, or may to some extent replace the previously described capsule and/or cap, or in another way simplify the process of loading, storing, and releasing the powder.

In some embodiments, the capsule and/or cap have concave inner spaces, and, after powder is filled into either or both of them, the two units snap or screw together to form a largely closed interior chamber. The capsule, or another component of the device, should further include an aerosol generating device, for example, an airflow-disrupting “grating”, through which air and powder flow, thereby yielding an aerosol for delivery to the user. The cap and/or the capsule should typically include air passageways, for example, on the respective ends of the enclosed compartments, so as to allow air to flow through upon inhalation. The design, for example, the size or shape of the air passageways, should provide sufficient airflow while minimizing powder loss.

In some embodiments, the cap 114 and/or the capsule 116 is designed to minimize powder loss. For example, as shown in FIG. 1E, the air passageways angle out to the sides, rather than straight through to the bottom, so as limit powder from falling out due to gravity, even when the device is held upright. When the powder is inside the capsule/cap, and shaking or other movements are minimal, powder may accumulate against the bottom surface of the passageways but minimally fall out through the side passageways.

In some embodiments, the need for balance between airflow and minimal powder loss may be achieved by a mechanism that enables air passageways to be alternatively open or closed. For example, in some embodiments, the capsule and cap components may fit together but remain capable of sliding against each other, to enable two configurations: in the closed configuration, the two are closer together, with elements at the base of the capsule blocking the air passageways of the cap; in the open configuration, the capsule and cap are separated slightly, allowing air to flow through the air passageways in the cap.

In some embodiments, the mouthpiece, capsule, and/or cap are designed for single use (perhaps disposable) or, alternatively, designed for multiple use. For example, in some embodiments, the capsule and cap may be disposable, and, optionally, available with a variety of food powders, while the mouthpiece may be reusable. In certain embodiments, pre-filled standard-sized capsules, for example, a gel capsule or blister pack, can be used. Such embodiments allow for easier filling, substitution, cleaning, and disposal. In addition, such embodiments allow for manufacture of multiple dose capsules. Such pre-filled capsules could be punctured, torn, cut or broken by design elements within the housing (for example, sharp points, blades, compressing the device, or twisting the device etc.) prior to use. The food product may thus be released into a chamber, for example, and become more susceptible to airflows generated during inhalation or activation; or the food product, as another example, may remain substantially within the original container but now be in fluidic communication with, and thus now susceptible to, airflows generated during inhalation and/or activation; etc. After activation and use, the emptied capsule could be removed from the compartment and disposed of conveniently. Alternatively, the capsule can be designed for multiple uses. For example, the capsule may be refillable.

In some embodiments, the housing is designed to allow for the incorporation of at least 2, for example, 3, 4, 5, 6, 7, 8, 9 or 10, capsules, thereby allowing, for example, the user to mix and match a variety of flavors in various amounts as desired. In some embodiments, the housing could be designed to allow for the loading of a set of multiple capsules to be activated one at a time, thus reducing the frequency of removing and replacing spent capsules.

In some embodiments, the device is designed for use by at least 2, for example, 3, 4, 5, 6, 7, 8, 9 or 10, users. For example, the device could be designed with multiple branches, each designed with an airflow directing element, so as to allow for simultaneous use by multiple users.

In certain aspects, the device includes a housing, a capsule and a cap. In alternative aspects, a device includes the housing and a cap, wherein both the housing and the cap are designed for use with capsules, for example, disposable or refillable capsules. In other aspects, the device encompasses disposable or refillable capsules. In other aspects, the device encompasses mouthpieces, used with a variety of aerosolized food products, aerosolized food product sources, and/or aerosolized food product containers.

It should be noted that the functionalities (i.e., food product containment, aerosol generation, aerosol delivery, airflow (and aerosol) direction, etc.) of the mouthpiece, capsule, cap, grating, mouthpiece disc, etc. may, in some embodiments, be associated with one or more potentially different physical units, while maintaining the same overall functionality. For example, in some embodiments, a single device unit may incorporate all functional aspects. In some embodiments, a mouthpiece may contain an aerosol generating device, an aerosol delivery device, and an airflow- (and aerosol-) directing device, and the food product container may be separate. In some embodiments, as previously described, food product may be contained within a capsule and cap, an aerosol generating device may be part of a capsule, and a mouthpiece with airflow-directing elements may be used to deliver the aerosol from the capsule/cap to the user.

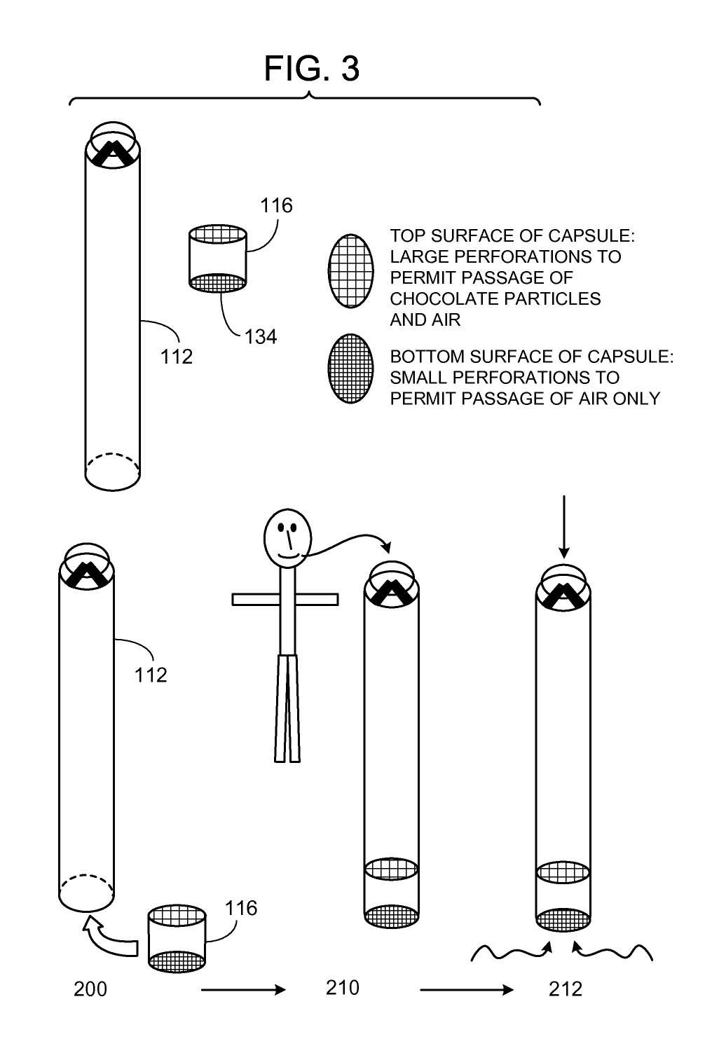

Referring to FIG. 3, a user operates a food delivery device 100 by loading the device 100 (step 200); bringing the device 100 to the user's mouth (step 210); and inhaling through the mouthpiece 112 (step 212) thereby causing air to enter the cap and the capsule through the air passageways. The air compels the food powder present in the capsule 116 to aerosolize through the aerosol generating device, for example, the grating, and subsequently enter the user's mouth via the mouthpiece 112.

FIG. 4 presents multiple views of an exemplary embodiment of a mouthpiece 112.

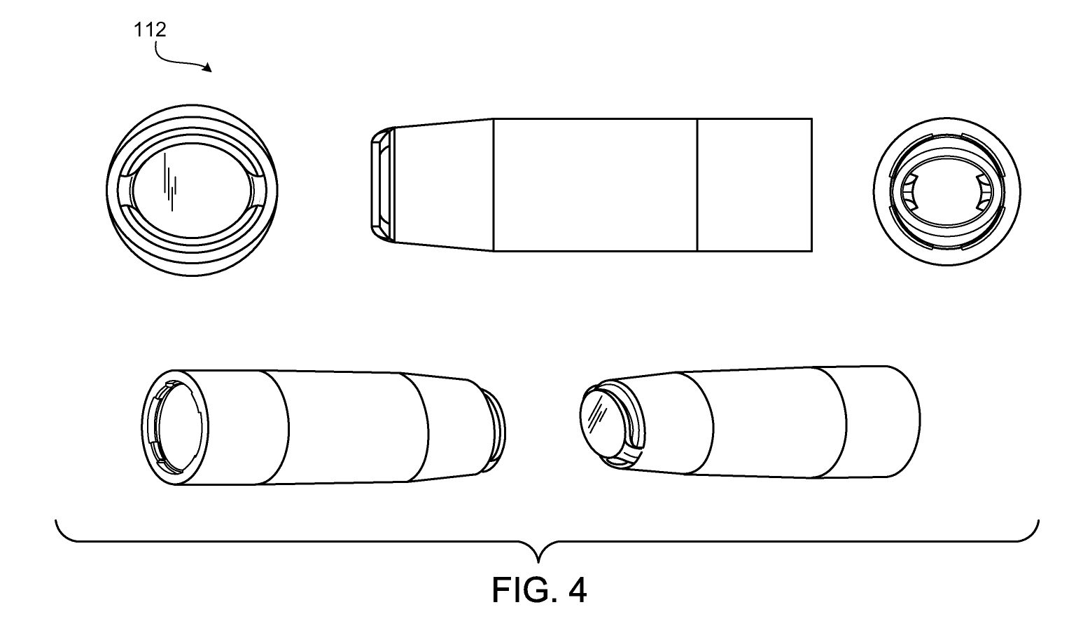

FIG. 5 presents multiple views of an exemplary embodiment of an end cap 114.

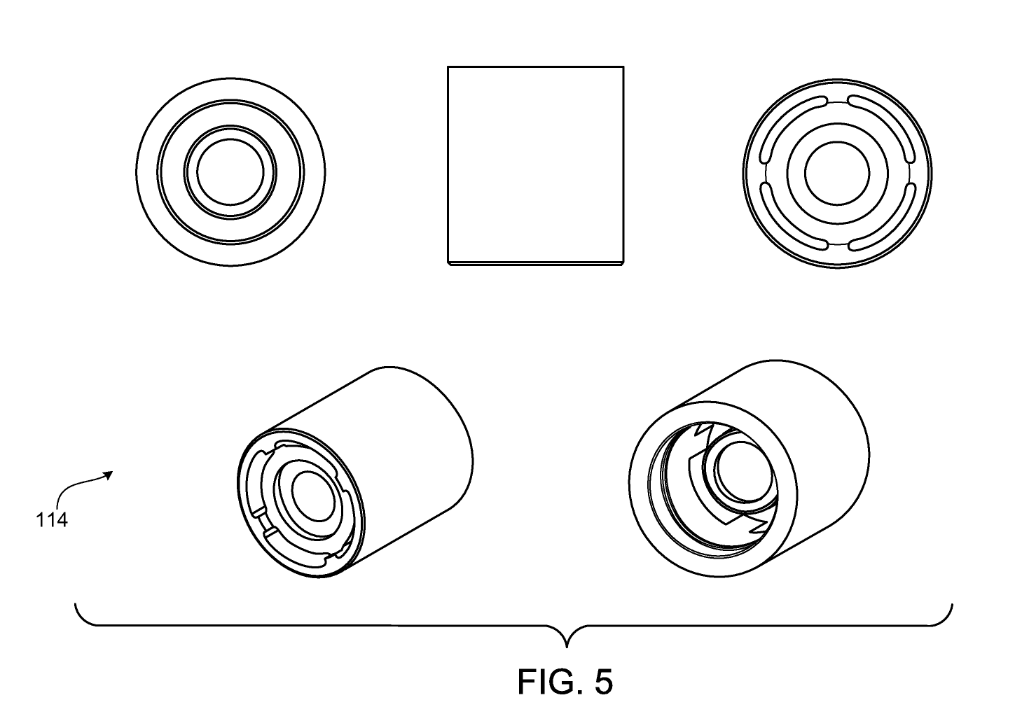

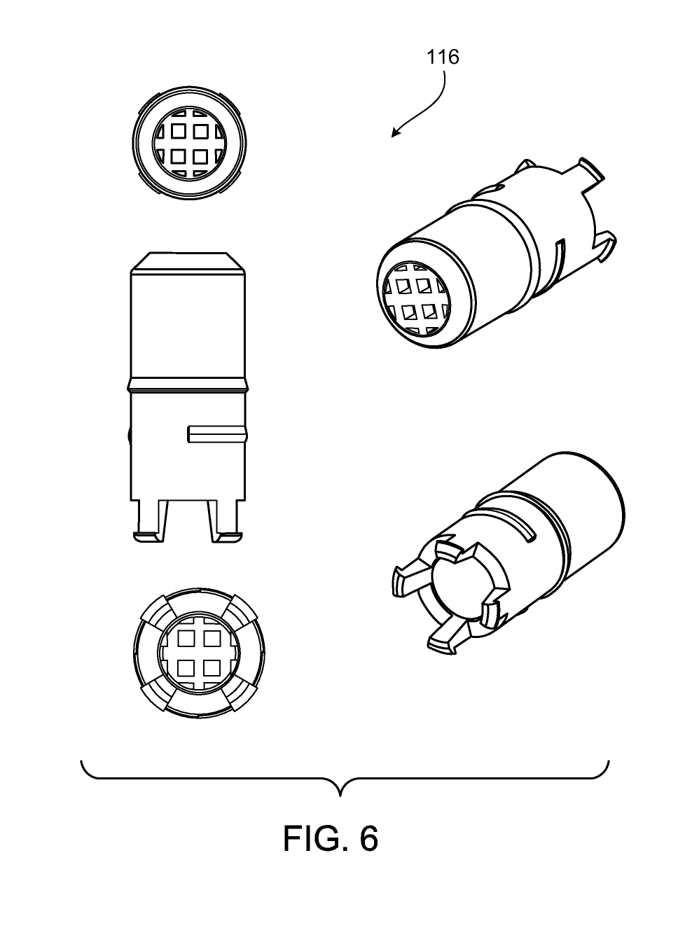

FIG. 6 presents multiple views of an exemplary embodiment of a capsule 116.

In some of the embodiments described above, the aerosol is generated at a particular point in time or over a small interval of time corresponding to a specific activation step, and/or the aerosol is generated by a user-dependent step. For example, in some cases aerosol generation is associated with one or more inhalation maneuvers by the user. In many of these embodiments, the food product is in a solid state, and may be a substantially dry powder. Our approach, however, is also directed to other series of embodiments, in which the aerosol is generated by a more continuous source, and/or a source external to the user; for example, one or more piezo-electric ultrasonic vibrating disc(s), an air pump, or a compressed air source. Some of these sources may be more appropriate for the generation of aerosols from substantially solid food products, while others may be more appropriate for the generation of aerosols from substantially liquid food products.

In some embodiments the food product is in a substantially liquid state, and aerosol generation by an ultrasound source in communication with the product involves atomization of the liquid in addition to subsequent formation of an aerosol cloud. For example, in some embodiments, the piezo-electric vibrating discs are placed within a liquid food product, and the ultrasonic vibrations of the discs generate an aerosol at the liquid surface.

In many of the embodiments previously described, an aerosol is generated within a housing, mouthpiece, capsule and/or cap, and directly delivered to the user via the housing and/or mouthpiece. In embodiments in which a substantially unconfined aerosol is used (e.g., an aerosol cloud, such as an aerosol cloud generated by an external source, such as an ultrasound source), it may be necessary to generate a highly concentrated aerosol in order to elicit a meaningful taste sensation in the subject. Highly concentrated aerosols, however, have greater rates of collision among particles, and over time, due to inertial impaction, diffusion, etc., the aerosol may become increasingly dilute as it spreads into surrounding air, or particles may coalesce (for example if it is a liquid aerosol). Other ranges of concentrations may be selected, e.g., to balance taste, aesthetics, and other factors relating to the consumption of substantially unconfined aerosolized food products. Accordingly, in some embodiments, an aerosol cloud may be confined within a pot or other (transparent, opaque, or translucent) medium or container. In a particular embodiment, a closed bubble may be used to confine the aerosol, preserving the aesthetics of a “floating” aerosol (whether it is floating within the container or bubble and/or the container or bubble itself is floating), while maintaining a higher aerosol concentration and enabling a more efficient delivery of the aerosol to the mouth than via open-air “eating” or open-air inhalation. The aerosol bubble or container itself may in some cases be edible. In some cases the bubble or container may open, providing access to the aerosol.

The external source, for example, the ultrasound source, may be placed in a confining media or container. In a medium or container that is not completely closed from the outside environment, for example, a pot, with the height of the medium or container selected to balance the need for protection from convection, diffusion, inertial impaction, and other forces, with the need for access to the aerosol, for example, via an open top, via small openings, via openings that can be closed at certain times, etc.

Referring to FIGS. 7A and 7B, a food delivery apparatus 300 includes a container 310 containing a food product 312. A force generator 314 (e.g., an air pump or compressed air source) is attached to the container 310. When activated, the force generator triggers the aerosolization of the food product 312 by passage through an aerosolizing component 316 and subsequent release of the food product 312 into the external environment. The resulting aerosol cloud 318 may then be consumed by, for example, displacement of the cloud or of the subject, or by inhalation.

Referring to FIG. 8, a prototype was constructed which included a hand pump as the force generator. The prototype aerosolized and released dehydrated mint particles using the hand-actuated aerosol generating apparatus.

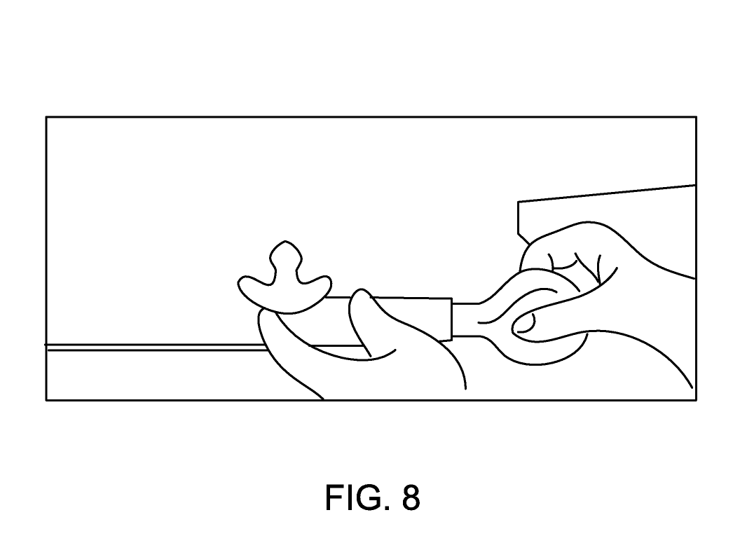

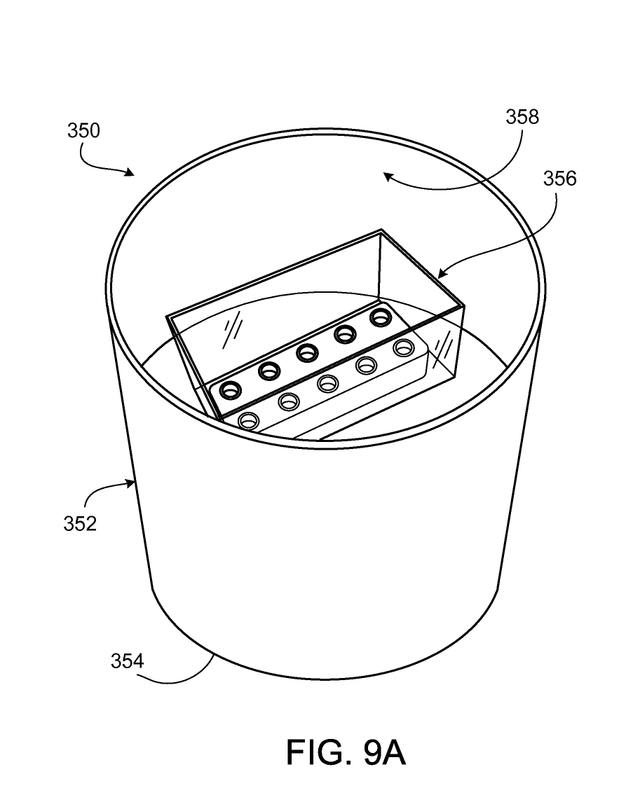

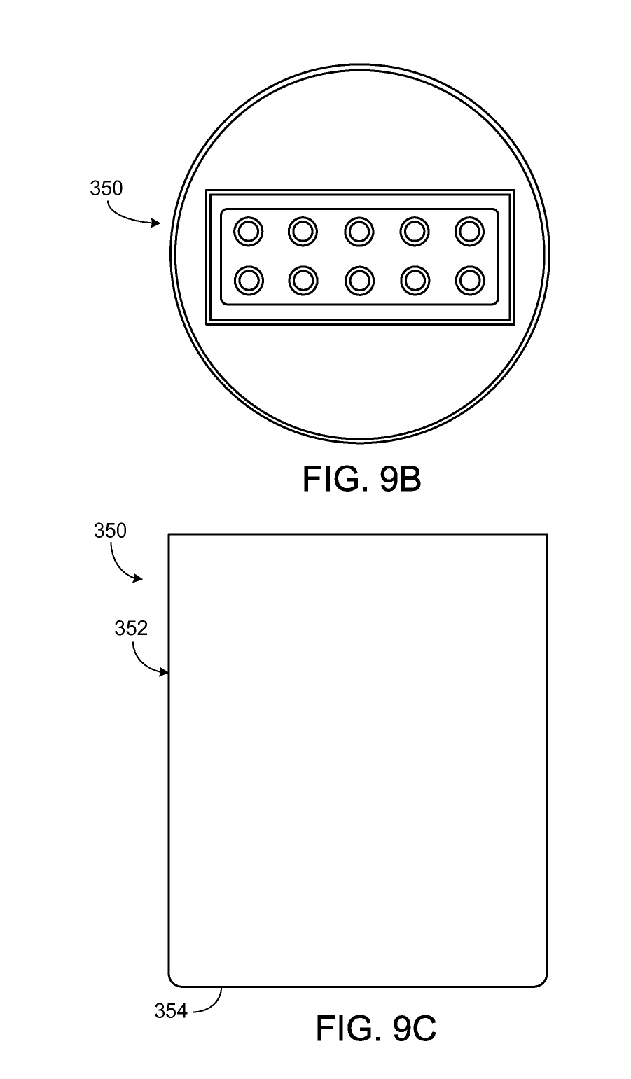

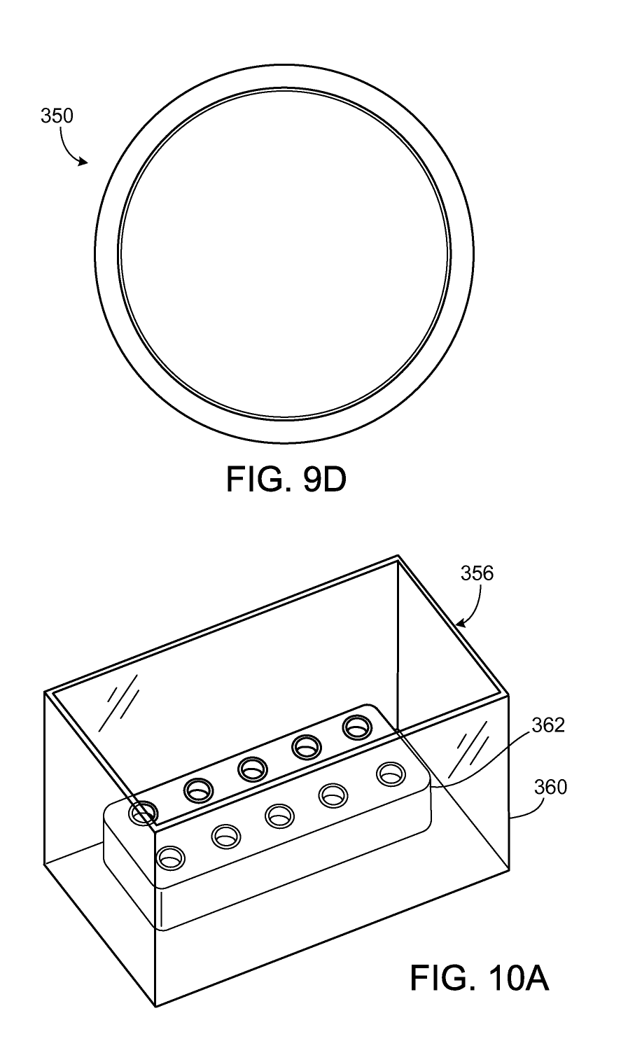

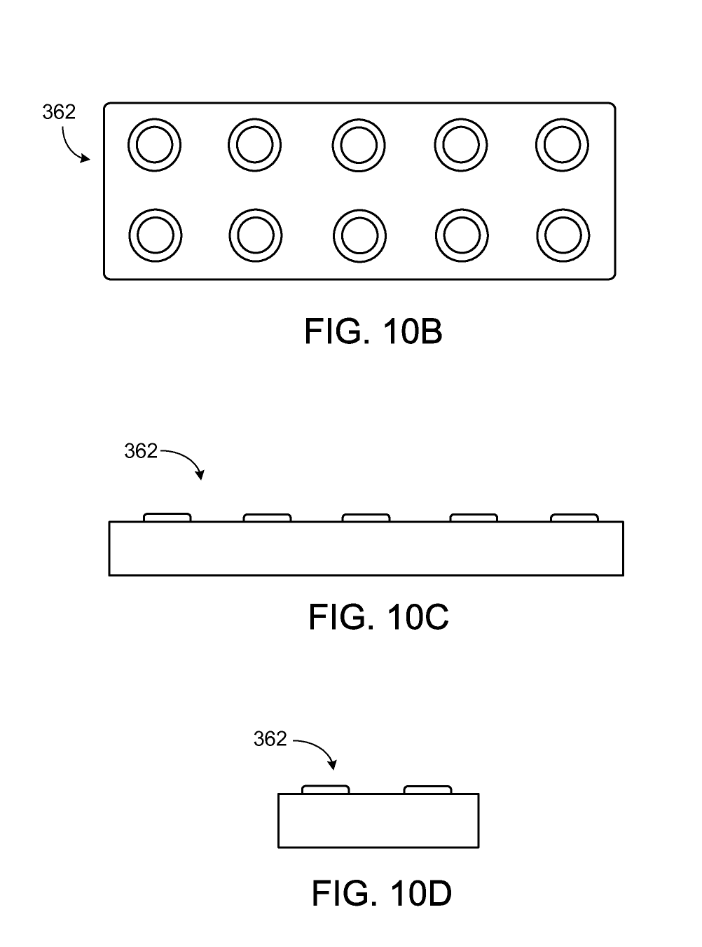

Referring to FIGS. 9A-9D, a food delivery apparatus 350 includes a container 352 with a base 354 configured to stably support the container on a supporting surface (e.g., a floor or a table). An aerosol generating device 356 is disposed in an inner cavity 358 of the container 352. The aerosol generating device 356 (shown in more detail in FIGS. 10A-10D) includes a clear plastic case 360 with an open top which receives an aerosol generator 362. The aerosol generator can be, for example, an ultrasonic or a piezoelectric generator.

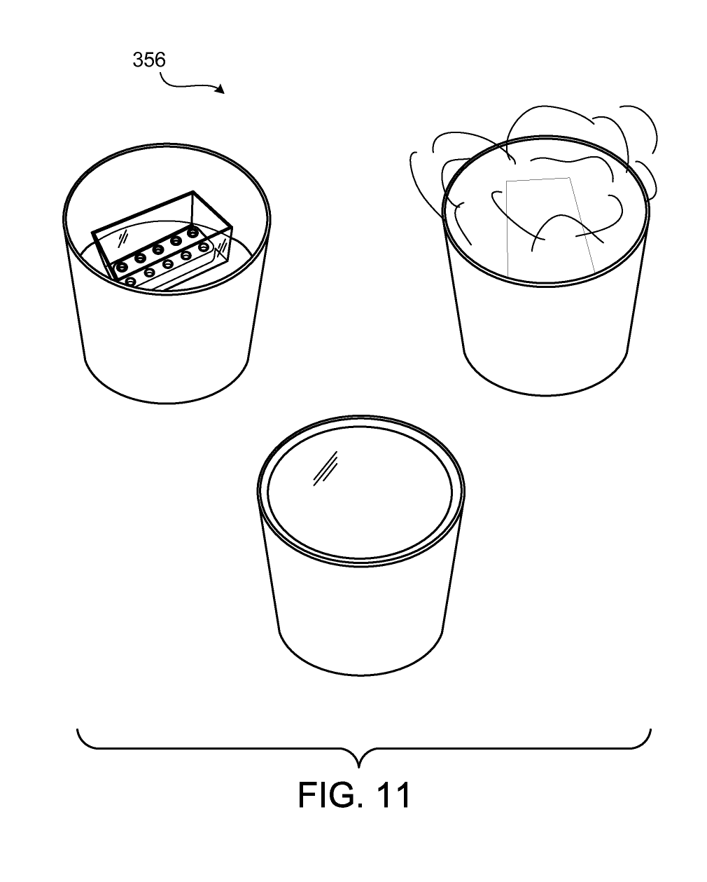

Referring to FIG. 11, a food product can be disposed in the case 360 of the aerosol generating device 356 of a food delivery apparatus 350. When the generator is activated, the food product is aerosolized and, in some cases, passes through the open top of the case 360 of the aerosol generating device 356 into the inner cavity 358 of the container 352. In some cases, the aerosol mixture is sufficiently dense that the aerosol mixture substantially remains within the container 352. The container 352 has an upper opening extending through the container to the interior cavity 358 that is vertically offset from the base when the food delivery apparatus 350 is disposed with the base 354 resting on a supporting surface. In some cases, an upper opening of the container can be closed with a cover.

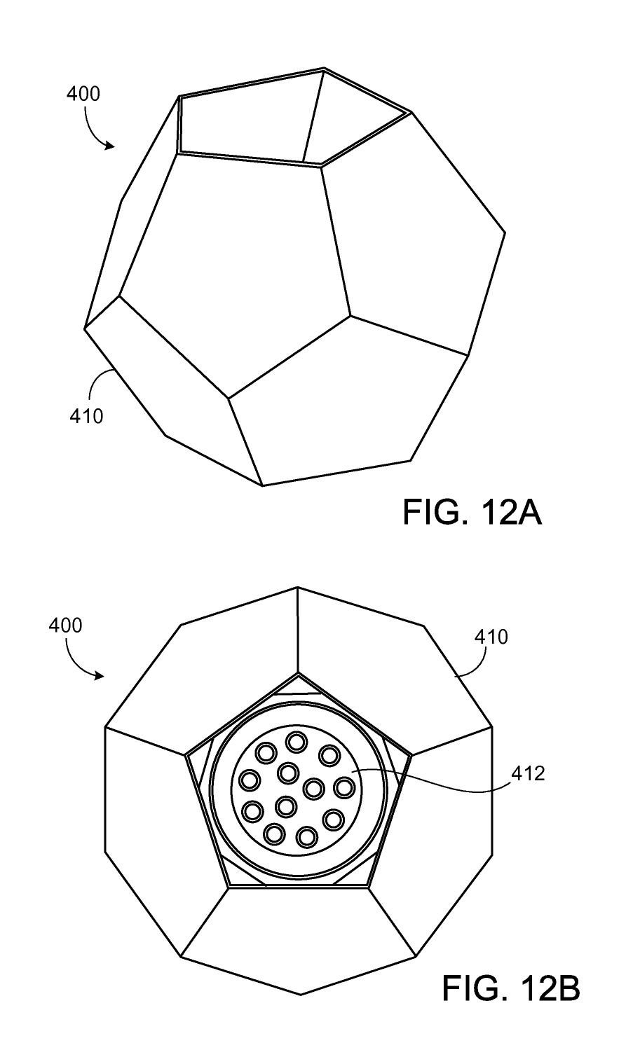

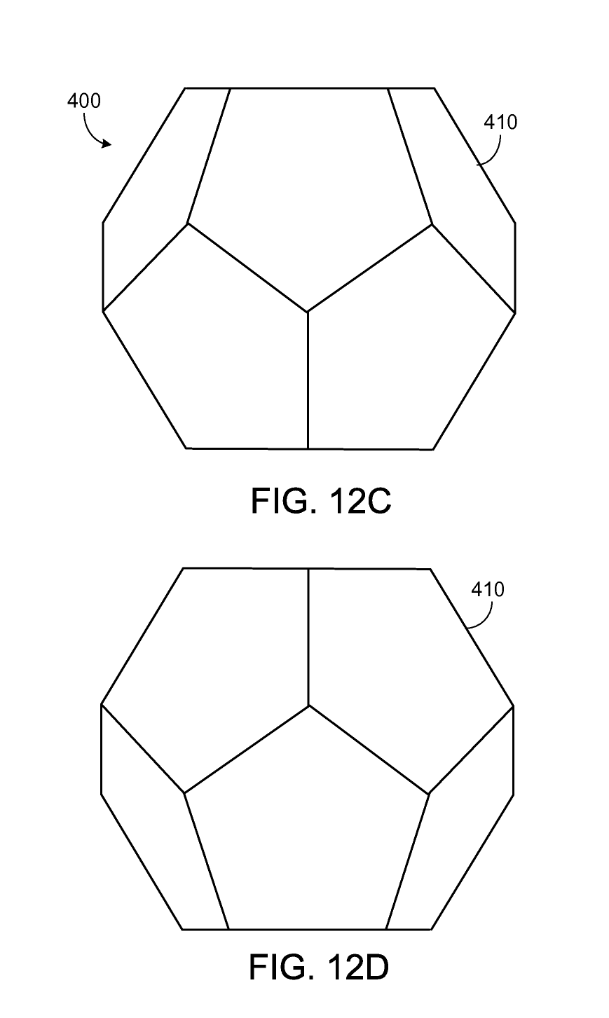

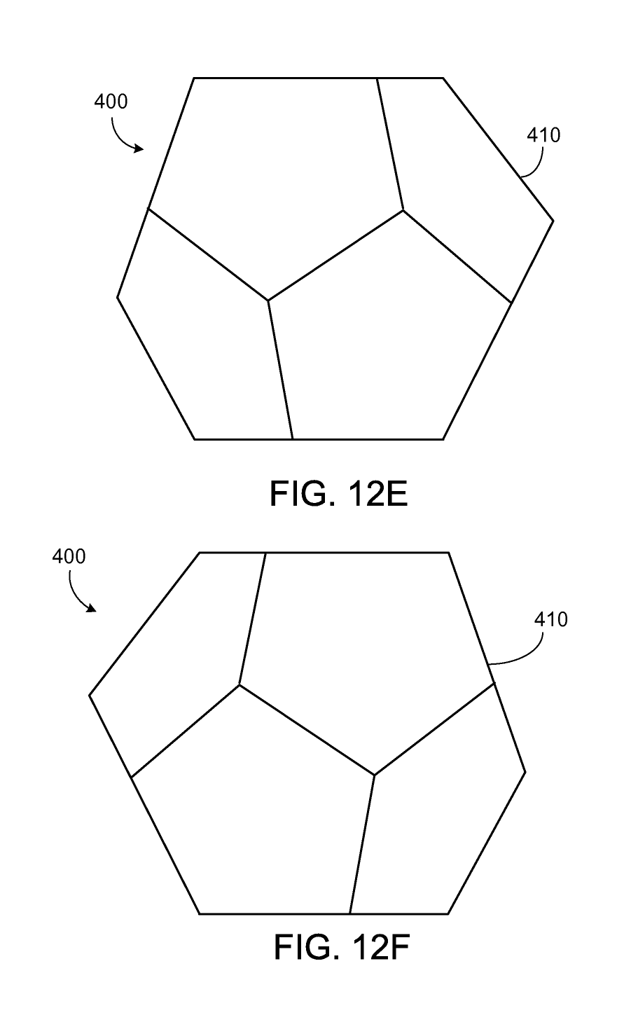

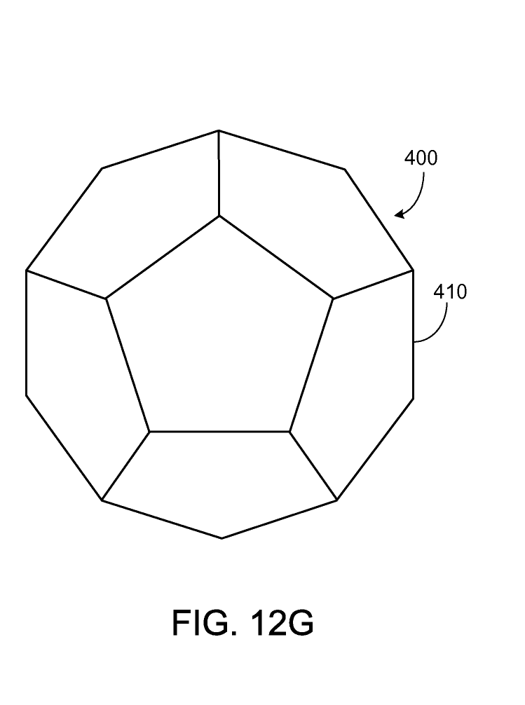

Food delivery apparatuses can be formed with other outer shapes. Referring to FIGS. 12A-12G, a similar food delivery apparatus 400 dodecahedron-shaped container 410 receives an aerosol generating device 412. Referring to FIG. 13, in use, the food delivery apparatus 400 can be disposed with an open face oriented directly upwards. Referring to FIG. 14, in use, the food delivery apparatus 400 can be disposed with an open face oriented upwards at an angle to the supporting surface.

A delivery mechanism can be used to carry the aerosol or portions of the aerosol to a user. In some embodiments, the delivery mechanism consists of a mouthpiece as previously described. Since the aerosol may be generated separately from the delivery device, the delivery device may consist solely of a mouthpiece with airflow-directing elements, which direct the aerosol to surfaces within the mouth upon inhalation as previously described. In some embodiments, it is convenient for the delivery device to be longer, for example to make it easier to access the aerosol without interfering with any aerosol confining structures or devices. In some embodiments, the delivery device is an elongated mouthpiece. In some embodiments, the delivery device is a mouthpiece connected to a separate device that essentially serves to extend the length of the mouthpiece; for example, a hollow cylinder (in some cases, this device may allow a user to use his/her own mouthpiece, while using the same lengthening device as other users; this may be considered a hygienic approach for multiple people to taste the aerosol, without requiring the fabrication of multiple long mouthpieces, which may be costly). In some embodiments, the delivery device is a “food straw”.

In some embodiments, the delivery device can be used directly, while in other embodiments, an additional intermediate step can be carried out to further confine smaller portions of the aerosol cloud, after (or during) aerosol generation and before delivery. This arrangement helps increase the proximity of a concentrated portion of the aerosol cloud within the delivery device, improving or making possible detectable and/or appreciable taste. This may also respond in part to hygienic concerns (whether realistic or illusory) about communal use of a single aerosol generating device, by separating the cloud into individual “portions” before consumption.

For example, with an aerosol-generating device (for example an ultrasonic device, within a liquid food product) in a pot or other container, the aerosol cloud can be collected into smaller containers, such as glasses, champagne flutes, soup ladles, etc., and then a delivery device (for example, a mouthpiece) can be used with the smaller containers. For example, a mouthpiece can be placed within the glass or other container, and by inhalation, the cloud within the glass or container is delivered to the user's mouth. Airflow-directing elements in the mouthpiece would help direct the particles to surfaces within the mouth and limit the extent to which particles could continue further into the respiratory tract.

In certain embodiments of a separate liquid aerosol generating device (e.g., that uses piezo-electric and/or ultrasound sources), typically there are a considerable number of larger drops that reach well beyond the range of the cloud. Thus, attempts to consume the food product from the cloud typically encourages use of a mechanism that allows the consumer to avoid being hit by these drops, for example, by blocking these drops, and/or staying at a distance from the cloud, and/or using a delivery device that minimizes exposure of the consumer to the drops.

Attempts to use gratings over the ultrasound source, with pore sizes smaller than the problematic larger drops, and larger than the cloud droplets, proved unsuccessful in testing. The cloud droplets, though able to fit through the pores, as a whole did not have sufficient kinetic energy to move easily past the grating to produce a large, dense cloud.

One effective solution is to provide a screen or cover above the cloud to restrict larger drops from projecting outward. In some embodiments, this cover concept can be realized by placing a larger cover over the overall container (see, e.g., FIG. 11) that is removed immediately before use. In some embodiments, a separate surface, or a side of the container, can extend somewhat over the position of the ultrasound source, thus blocking some projecting drops. In some embodiments, access to the cloud can be via a side opening or space (see, e.g., FIG. 14). In some embodiments, the ultrasound source can be placed at an angle, such that it faces a side of the container, or any non-open portion of the overall device, and thus projects the drops primarily to the corresponding opposite side, rather than out the opening or out an open side (see, e.g., FIG. 13).

Many equivalents to these embodiments are possible, including systems where the container has a variety of dimensions and orientations, and/or where there are covers with various sizes, shapes, and orientations, which may or may not be attached or connected to the rest of the apparatus. Overall, the presence of a solid surface in any form that prevents larger drops from projecting out, located at some distance from the source to allow the cloud to be easily created, is to be considered a variation on the embodiments described herein.

An alternative solution is the use of a delivery device that allows for consumption at a distance. For example, a mouthpiece with airflow-directing elements can be used. In some embodiments, a mouthpiece can be elongated and serve as a “straw”, for delivery over a longer distance. In some embodiments, the elongated mouthpiece may consist of two parts—a mouthpiece and an extension piece. For example, the mouthpiece may have airflow-directing elements, and may incorporate a cylinder of a certain diameter and length. The extension piece may, for example, connect with (e.g., fit, snap, screw, etc. into) the mouthpiece, and may have a similar diameter, and be of some length. In this latter system the mouthpieces and the extension pieces may be replaced independently (e.g. each user may have one mouthpiece and, each in turn, use the same extension piece).

### Activation of Aerosolization and Delivery of Food Product

The aerosol generating device is any device capable of producing an aerosol of desired characteristics (i.e., particle size, airborne time/suspension duration, emitted dose, etc.). In addition to the aerosol generating device, there may be a delivery device, such as an additional airflow constraining device, a confined space in which the aerosol is contained, an air passage in an inhaler, a mouthpiece, airflow-directing elements, or other devices or structures, that enable, facilitate, or optimize the delivery of the aerosol to the subject's mouth. For example, FIGS. 2A-6 illustrate the capsule and cap, which in many embodiments serve as a food product container and incorporate an aerosol-generating device (consisting primarily of the grating). In many embodiments, the capsule and cap are connected to each other and to a mouthpiece with airflow-directing elements, where the mouthpiece would serve as a delivery device.

By controlling gravitational and inertial forces, the airflow-directing elements found in some embodiments enable delivery of the aerosol cloud substantially to surfaces within the mouth rather than further down the respiratory tract. This aspect of the technology is highly relevant to a number of potential applications of food aerosols. Indeed the same such delivery device can make possible delivery of a wide range of food aerosols, generated in a number of different ways, to a consumer, while minimizing or eliminating coughing and potential interactions with surfaces of the respiratory system beyond the mouth.

The design of any of the devices or structures associated with this technology may also take into consideration and attempt to reduce any tendency to cough, gag, or otherwise react unfavorably to the aerosol.

These devices, and associated devices (such as a food-containing device), can be embodied in a vast number of different ways. The devices described herein are meant to be exemplary.

Triggering the aerosolization of the food product and subsequent delivery of the resulting aerosolized food product may occur by a variety of means including, but not limited to, acts of respiration, device activation, bodily displacement, aerosol displacement and a combination thereof. For example, such acts may include:
a) an act of respiration, for example, by inhalation on a mouthpiece, resulting in exposure of the food product to the aerosol generating device and delivery of the aerosolized food product to the mouth; and/or
b) an act of device activation, including, but not limited to, the activation of an ultrasound source, the actuation of a pump, the activation of a compressed air source, the activation of an impeller, the puncturing of a container, the opening of an air passage, that at least in part causes or helps to cause a food product to aerosolize (the aerosol thus formed may be in a substantially confined space (e.g., a spacer), or a substantially open space (e.g., as a “cloud” in air or in a confined structure)); and/or
c) an act of respiration directed “on” or “toward” an aerosol (e.g., that is contained in a spacer device, freely floating as a cloud or contained within a larger structure), and that may be facilitated by the use of a straw, mouthpiece, or other apparatus, thereby leading to food deposition substantially in the mouth; and/or
d) an act of bodily displacement, such as walking or leaning (possibly in conjunction with a particular placement or positioning of the mouth, tongue, or other body part in a specific way), that exposes a subject's mouth to an aerosol cloud, or portion thereof, thereby leading to food deposition substantially in the mouth, and/or
e) an act of aerosol displacement, caused by, for example, an air current, a thermal or pressure gradient, inertial impaction, diffusion, or gravity, that brings an aerosol cloud, or portion thereof, to a position so as to expose a subject's mouth to the aerosol cloud, thereby leading to food deposition substantially in the mouth (even where aerosol displacement results in dilution of the particle concentration and spreading out the cloud); and/or
f) an additional act of device activation, device use, space constraining, airflow confinement, etc., or of placement or positioning of the mouth, lips, tongue, jaw, head, or other body part in a particular configuration, shape, etc.; or other additional action that helps produce the proper aerosolization and/or delivery and/or tasting of the food product (e.g., use of a food straw, opening/closing of a containing chamber, lifting of the tongue to divert airflow, etc.). Such acts may be used to help reduce a tendency to cough, gag, or otherwise react unfavorably to the food product.

All references to a powder, liquid, aerosol, cloud, particle, etc. made herein may equivalently refer to some fraction or portion of the total amount of the powder, liquid, aerosol, cloud, etc.

The device itself may be designed for single use (for example, disposable) or multiuse, for example, where the dosage capsule is replaced or the dosage chamber refilled. Alternatively, or in addition, parts of the device, for example, the mouthpiece, the food-containing apparatus, the capsule, and/or the cap, may be disposable. In some embodiments, the device may incorporate a force-generating mechanism, such as a pump or compressed air source, to aerosolize the food product. In some embodiments, the device may incorporate a propellant.

In some embodiments, the device may be designed for “single action”, “repeated action”, or “continuous action” aerosolization and/or delivery, depending on whether it is intended to aerosolize and/or deliver the product in a single, short-term step (e.g., one inhalation on an inhalation-triggered apparatus), in multiple discrete steps (e.g., multiple inhalations on an inhalation-triggered apparatus), or over a longer-term continuous step (e.g., maintaining an aerosol cloud in open air), where “step” can refer to any combination of simultaneous and/or sequential processes by which the device aerosolizes and/or delivers the product. Many factors, including whether the device is intended for use by one subject or multiple subjects at a time, will help determine which of these step sequences (if any) is appropriate for any particular embodiment.

The device might also include additions, such as spacers, lights, valves, etc., to enhance the visual effect and/or the control over the aerosol and/or dosage. These additions may also enhance the experience of inhaling the aerosols.

In some embodiments, the body of the entire apparatus, or parts of the apparatus, could be manufactured of an edible/ingestible substance, such as a cookie, cracker, chocolate, or sugar product, etc. This would allow the device to be enjoyed either during the aerosol delivery or afterwards, thus enhancing the overall experience.

In some embodiments, the device may be similar to an inhaler or inhalation device, such as a dry powder inhaler (DPI) or metered dose inhaler (MDI); a “pot” that holds an ultrasound source and confines somewhat the aerosol cloud produced by the source; a “fountain” that ejects and/or circulates the aerosol; a hand-held pump device; a compressed air device; a food straw device; a multi-person, communal device; a tabletop device. A variety of materials may be used to form the device, or parts thereof, including: plastics (e.g. polycarbonates, which are relatively strong, polypropylene, acrylonitrile butadiene styrene, polyethylene, etc.), various metals, glass, cardboard, rigid paper, etc.

In some embodiments, the aerosolized food product should be of a determined size, i.e., of sufficient size to limit entry into the respiratory tract but of small enough size to allow for suspension in the air. In some embodiments, particle size may be a manufacturing requirement of pre-atomized, generally solid food products, for example the food products placed inside the capsule/cap of certain embodiments, or certain dry food products used in association with an air pump or compressed air source. In some embodiments, particle size may be a requirement of the aerosol-generating device, for (generally liquid) food products that are only atomized upon aerosol generation, for example the food products used in association with ultrasound sources to produce an aerosol cloud.

In some embodiments, the predetermined, mean size of the aerosolized food product is at least 1, 2, 3, 4, 5, 10, 15, 20, 25, 30, 35, 40, 45, 50, 55, 60, 70, 75, 80, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 325, 350, 375, 400, 425, 450, 475, or 500 microns. In some embodiments, the predetermined, mean size of the aerosolized food product is less than 500, 450, 400, 350, 325, 300, 275, 250, 245, 240, 235, 230, 225, 220, 215, 210, 205, 200, 195, 190, 185, 180, 175, 150, 140, 130, 120, 110, 100, 90, 80, 70, 60, 50, 40, 30, 20, or 10 microns in size. Ranges intermediate to those recited above, e.g., about 50 microns to about 215 microns, are also intended to be part of this disclosure. For example, ranges of values using a combination of any of the above recited values as upper and/or lower limits are intended to be included.

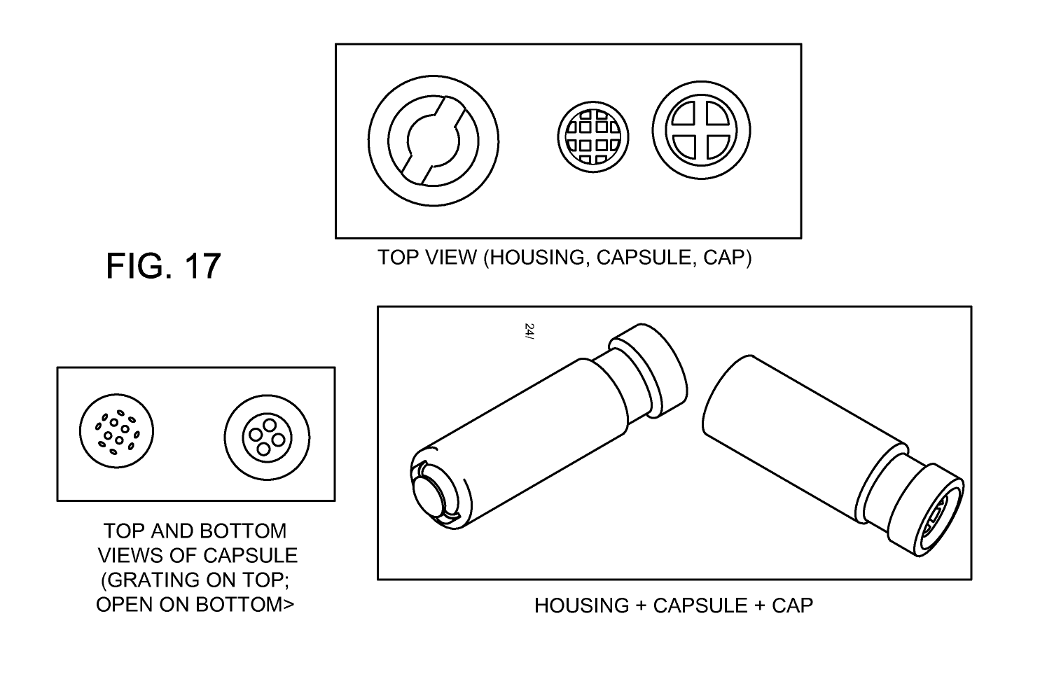

Especially, but not exclusively, in some embodiments in which intake is by inhalation, minimum particle size is an important feature of the approach. The food aerosol particles are designed to be substantially delivered and deposited into the mouth, for example by the forces of gravity or inertial impaction, but to not be easily delivered and deposited substantially further into the respiratory tract, for example the trachea or lungs. Such food particles would thus possess a size larger than that which focuses penetration into the lungs (i.e., larger than about 10 microns). For example, breath-activated inhaler-like devices, such as the devices shown (in part or in whole) in FIGS. 5-17, generate an aerosol that would fairly easily follow the inhaled air toward the lungs were it not for the aerosol particles' larger size (and the delivery device's airflow-directing elements).

Especially, but not exclusively, in embodiments in which intake is by displacement of the subject or of the aerosol (e.g., with an aerosol cloud), maximum particle size is an important feature of the approach. Indeed, the aerosol cloud must remain suspended in air for at least a brief time so that displacement into the mouth can occur. Thus the particles must not be so large such that they rapidly settle from the air. This will greatly depend on the force(s) and/or mechanism(s) by which the particles are held in the air (e.g., by “natural” forces alone, such as inertia, diffusion, etc., or by additional forces, such as an impeller, air currents, convection, etc.). Accordingly, in some embodiments, the particles should be less than about 500 microns under typical suspension forces and mechanisms. For example, ultrasound sources in liquid food products can produce a standing aerosol cloud that, so long as convection is minimal, balances gravity, diffusion, inertial impaction, and other forces, to stay suspended in the air.

The specific parameters of the apparatus and intake method will in part determine whether the subject is “inhaling” or “eating” when intake of the aerosol occurs. This generally corresponds to (1) whether the aerosol is entering the subject's mouth and/or throat via inhaled air (physiologically, while the epiglottis is directing the air into the trachea toward the lungs) or whether the aerosol is entering the subject's mouth by another method (such as displacement of the aerosol or of the subject), and (2) whether the subject's expectation is that the aerosol is a kind of food to be (eventually) swallowed (physiologically, while the epiglottis is blocking passage to the trachea). In any case, it should be further noted that the food product, after deposition in the mouth, may be eventually swallowed and consumed essentially as any other typical food product.

In some cases, the aerosol may be carried via inhaled air that flows all the way to the lungs (for example, like the inhalation a smoker may have, which carries air and smoke through/from the cigarette, into the lungs). In some cases, the aerosol may be carried via “sucked” air that “stops” in the mouth (more like the approach used with a typical straw and beverage, or with cigars). (In some cases, elements of both approaches may be suitable.) This potential distinction may have important implications for a food aerosol device. For example, in the case in which the particles are carried by air that continues directly to the lungs, preventing deposition of particles too far into the respiratory tract is more dependent on the physical parameters of the particles, airflow, etc. In the case in which the particles are carried by air that is sucked into the mouth, it may be possible to carry particles of mean sizes, or with other properties, that would normally allow them to extend further than desirable into the respiratory system, but that, by virtue of the airflow “stopping” before the lungs, have them fall substantially into the mouth anyway.

In some embodiments of devices in which an aerosol is generated by inhalation, e.g. the devices shown in FIGS. 5, 6, and 20, relatively dry, solid food powders of appropriate size can be used as the food product. Preliminary tests have shown that the water-solubility of the dry powders used plays a role in the taste and potential coughing reflex resulting from intake of the aerosolized food product. Powders of particles that tend to be more rapidly water-soluble, such as ground chocolate bars, or certain chocolate-based powders, give rise to a generally pleasing reaction upon contact of the particles with the tongue and other surfaces within the mouth. In the case of ground chocolate bars, for example, the effect is in some cases similar to that of sensing chocolate melt very rapidly in one's mouth. Particles that are less water-soluble, such as certain ground-cocoa-based powder products, tend to be considered harsher and more likely to elicit less pleasurable reactions, such as a dry-mouth sensation or coughing. However, in some instances, a combination of both kinds of powders, in varying proportions, provides interesting flavor complexity.

In some embodiments in which a liquid aerosol is generated, such as in the devices illustrated in FIGS. 9A-14, the aerosol generation and delivery devices are constrained by the need to have sufficient aerosol quantity and/or concentration to elicit a meaningful taste sensation. Thus in some embodiments, the density of the aerosol cloud, and the quantity of aerosol consumed in one inhalation or other single delivery step, must be above a minimum threshold, depending on the user's sensibility to taste, the food product, and many other conditions.

In some embodiments in which a liquid aerosol is generated, for example, with ultrasound sources in liquid food product, particles suspended in the liquid (for example if the liquid is colloidal) must be generally smaller than the size of the aerosol particles that are to be generated for the source to efficiently produce an aerosol. In addition, in some embodiments with liquid aerosols, for example some embodiments with ultrasound sources in liquid food product, surfactants cannot play a critical role in producing the desired taste (which is the case, according to preliminary tests, of wine) since the aerosolization separates the surfactants from the rest of the food product, giving rise to a greater proportion of surfactants in the liquid, and thus a greater proportion of other food components in the cloud (e.g., in the case of wine, more acidic substances) that distort the true flavor of the food product.

### Food Products, Including Aerosol Powders

By designing a food form that can be aerosolized (particles much larger than 500 microns fall quickly out of the air unless supported by an external force) and yet has sufficiently large particles (greater than approximately 1, 2, 3, 4, 5, 10, 15 or 20 microns) such that few or no particles enter the lungs on inspiration, our technology results in deposition and delivery into the mouth. Ideally, the particles would be designed (sized) such that, for example, at least about 50%, at least about 60%, at least about 70%, at least about 80%, at least about 90%, at least about 95%, at least about 97%, or at least about 99% of the particles deposit in the mouth and do not extend further into the respiratory tract. The design of the particles should also take into consideration reducing any tendency to cough, gag, or otherwise react unfavorably to the aerosol.

Dry powder particles can be created through a number of different methods. Initially, the food product may be dehydrated. Alternatively or in addition, where the food is a more malleable or liquid based food, the food may be frozen first to facilitate subsequent grinding or chopping. The food product may subsequently be ground to form food particles of the appropriate size. Grinding of the food products can be performed by use of a mortar and pestle. Alternatively or in addition, food products may be chopped, for example using a mechanical or electrical grinder, knives, etc. The resulting ground or chopped food particles can subsequently be filtered through sieves (for example by hand, using an electrical or mechanical sieve shaker, by an air classification system, by a screening system, etc.) to achieve the appropriate particle size. Another approach is to use a powder mill that grinds down larger particles into pre-defined sizes. Spray drying, in which a mixture of water and the material to be dried is forced through a nozzle into a high-temperature drum, instantly evaporating the water droplets clinging to the material, may also be utilized. These methods, in addition to others, would allow for the creation of specifically sized particles capable of being aerosolized, but large enough not to pass easily through the mouth and throat and continue into the respiratory tract.

These dry powder particles could be created from a single food or ingredient, such as chocolate, coffee, or truffles, or from a combination of foods or ingredients, such as combinations representative of an entire dish or meal (e.g., mixed fruits or meat and potatoes). In the case of chocolate, chocolate bars, chocolate powder, cocoa powder, and other forms and varieties of foods derived from the cocoa plant may be used. In addition, in some cases, spices and other (natural or artificial) flavorings may be used alone or in combination with such food ingredients to create other tastes or sensations (e.g., natural or artificial chocolate, raspberry, mango, mint, vanilla, cinnamon, caramel, and/or coffee flavors). Additionally, the apparatus may contain a single dose of food product or multiple doses/portions of the food product. In addition, they may be made from largely liquid products, for example by extracting dissolved solids or using other solid components. In some embodiments, flavors can be experienced while using less of the actual product compared to normal ingestion. In addition, by mixing different powders, new flavors can be created.

The food aerosol may also be a liquid that is aerosolized, for example by an ultrasound source that is in communication with a liquid food product; or by a “spray” mechanism, similar to those for liquids and gases in spray cans (“aerosol cans”) or vaporizers. Such liquids may be prepared by a variety of processes such that they are or include a concentrate, additive, extract, or other form of a food product that in some way preserves or enhances, and can deliver, a taste.

A liquid aerosol may also be generated by an ultrasonic device, such as vibrating piezo-electric discs placed within a container of liquid food product.

Depending on the food product(s) and device(s) used, the food product may be stored and/or contained in the form of a tablet or pill, in a blister pack, within a capsule, as simply a powder in a jar-like container, and/or in a tray, box, container, thermos, bottle, etc.

In some embodiments, it is possible to deliver odors using appropriately designed and appropriately sized particles, which may be utilized independently or in addition to embodiments described herein, i.e., in addition to delivery of aerosolized food product so as to enhance the aesthetic experience.

Please note that “food product”, “aerosol”, “particle”, and other similar terms are used throughout this document, and though they may typically refer to small solid particles derived from foods, these terms may in some cases refer to any of the other food-derived products described herein.

### Other Potential Properties of the Aerosols

Humidity or other ambient atmospheric conditions, which may vary over time and/or space, can be used to trigger time- or location-dependent changes in the aerosol and/or in the sensory detection and transduction it initiates in the subject(s). These conditional triggers may lead the particles to take on different gustatory, olfactory, aerodynamic, chemical, physical, geometric, and/or other properties, which in turn may alter the taste, texture, color, size, aerosolizability, and/or other aspect of the particles.

The purpose of such conditional triggers is generally to create a more interesting and dynamic experience for the subject(s). The trigger may depend on reaching a threshold atmospheric condition (e.g., greater than 50% humidity), or a threshold associated with the subject. The atmospheric condition may change the aerosol particles themselves and/or may allow them to interact differently with the subject's sensory mechanisms. For example, in low-humidity air, an aerosol may take on one chemical/physical state, which gives it a first taste, and in high-humidity air, it may take on a different chemical/physical state, which gives it a second taste. As another example, an aerosolized aerosol may have initially no taste and/or odor, or an initial taste and/or odor reminiscent of a certain food product (which may, for example, be detected initially by a subject through the olfactory system, before intake of the aerosol through the mouth); and after the aerosol is taken through the mouth, the ambient environment of the mouth may trigger a change in the aerosol that gives it a taste and/or odor, or new taste and/or odor reminiscent of a different food product. Over time but while the food product is still in the mouth, it may continue to evolve, evoking different sensations for the subject. Mechanisms like these could be used to create the impression of sequentially eating different courses of a meal, such as an appetizer followed by a main course followed by dessert.

### Time Airborne/Suspension Time

Depending on the particular embodiment, the food product can be in aerosol form (airborne) for different durations. For example, in the case of an inhaler-based device, the food product typically remains airborne only for the time over which inhalation and intake occur, which may be, for example, up to about ½ second, up to about 1 second, up to about 3 seconds, up to about 5 seconds, up to about 8 seconds, up to about 10 seconds, up to about 15 seconds, or possibly greater time periods. Alternatively, where the food delivery device operates by producing an aerosol cloud, the food product may remain suspended in the air for, for example, at least about 1, 2, 3, 4, 5, 6, 7, 8, 9, 10, 15, 20, 25, 30 or 60 seconds, or at least about 2, 5, 10, 15, 20, 30, 45, 60, 90, 120, or 180 minutes. Mechanical agitation of the aerosol cloud, for example, by convection, can serve to increase the time during which the aerosol cloud is suspended.

### Applications

Our apparatus can transform how food is experienced, allowing for an enhanced aesthetic experience of food. For example, the apparatus can allow subjects to experience food by exposing themselves to, for example, rooms filled with food clouds, immersive chambers and food straws. Indeed, businesses, restaurants and nightclubs could provide such “food experiences”.

In some embodiments, our technology can allow subjects to experience food by exposing themselves to aerosolized food via individual, hand-held, and/or portable devices. In some embodiments, our technology may be used in and/or associated with social contexts similar to candy eating or cigarette smoking. For example, some embodiments may be carried about and used at various points throughout the day, or used simultaneously by multiple users.

In various other embodiments, the technology can allow multiple subjects to have a communal experience while appreciating food aerosols, for example in embodiments in which a single aerosol-generating device is associated to multiple delivery devices, such as a pot-like container confining a liquid aerosol cloud that is delivered by breath actuation to multiple subjects each using independent mouthpiece devices with airflow-directing elements.

In addition, the apparatus can serve to provide nutrition to subjects either who are incapable of chewing or for whom delivery of food is not convenient. For example, the food delivery apparatus may be useful for elderly or young children, for whom chewing or feeding is inconvenient. In addition, individuals with medical conditions that require them to be fed in particular ways (e.g., by a feeding tube or intravenously) may use certain embodiments of this invention as a way to experience and taste food again.

The apparatus can also serve to facilitate the intake of medication that may not be of a pleasurable taste. If used in conjunction with delivery of the medication, e.g. orally, the apparatus can provide an additional flavor that masks the flavor of the medication.

Alternatively, the proposed food delivery apparatus may be used for weight control or addiction mitigation applications. For example, the food delivery apparatus can allow for subjects to consume relatively small or negligible quantities of food products or certain unhealthy or addictive substances, and the exposure to the food particles via the apparatus may provide a sensation or satisfaction normally associated with the consumption of a larger quantity of the food or substance in question, thereby potentially satisfying hunger or addictive urges without the (potentially negative) consequences of actually consuming larger amounts of the substance(s). In some cases, this may be due to the higher surface area of the food product exposed to surfaces of the mouth, for example exposed to taste receptors, relative to the overall quantity (e.g., mass) of food product. Indeed, the food delivery apparatus may form a basis for dieting, weight control and healthy eating programs (for example, by satisfying cravings for sweets, fatty foods, chocolate and caffeine) and addiction treatment (for example, by satisfying urges for alcohol, smoking, drugs but in much smaller, less harmful amounts).

In addition, the food delivery apparatus may be used to improve quality of life, for example, with respect to individuals subject to special dietary restrictions. For example, the food delivery apparatus may allow individuals who suffer from allergies (e.g., gluten allergy) or other conditions (e.g., lactose intolerance) that normally prevent them from consuming specific products to consume relatively small or negligible quantities of these products without triggering an allergic or physical reaction, while possibly providing a sensation or satisfaction normally associated with the consumption of a larger quantity of the food or substance in question.

Additionally, the food delivery apparatus can serve as a means for taste-testing a number of items in a simple and efficient way. For example, a patron at a restaurant can taste test various dishes on the menu before making a selection. Additionally, chefs may use the food delivery apparatus to test combinations of foods while cooking or designing a recipe. Similarly, the apparatus may serve as an aid in cooking lessons, as an international “dining” experience for a subject, as a way to teach children about food, etc.

Other useful applications of the food delivery apparatus include, but are not limited to hunger relief (e.g., in the emergency conditions of a famine) and for animal feedings.

### EXAMPLES

The following examples are expected to be illustrative and do not limit the scope of the claims.

### Example 1

To help determine an ideal particle size for food aerosolization from a single-actuation dry powder inhaler, mint powder samples, with approximate initial mean particle sizes of at least 140 microns, were utilized. A mortar and pestle was used to grind the dry mint powder. Mean particle size was reduced to as low as ˜11 microns, as determined using a HELOS-RODOS particle sizing system. Particles of different sizes were placed in separate size 3 capsules and tested in a hand-held inhaler.

### Results

Tests were made with samples of mint particles with approximate mean particle sizes of 140, 111, 72, 40, 18, and 11 microns. Capsules (each containing approximately 30-120 mg of mint) were placed in the aerosolizer and punctured, and the inhaler was actuated to release the particles into the air. A large fraction of the particles could be seen to fall within 5 seconds after release, though this fraction decreased with decreasing sample particle size. It was relatively high in tests with approximate mean particle sizes of 140, 111, and 72 microns, and relatively low in tests with approximate mean particle sizes of 40, 18, and 11 microns. Tests with approximate mean particle sizes of 18 and 11 microns produced fairly mist-like and uniform plumes, with fewer visually distinct particles.

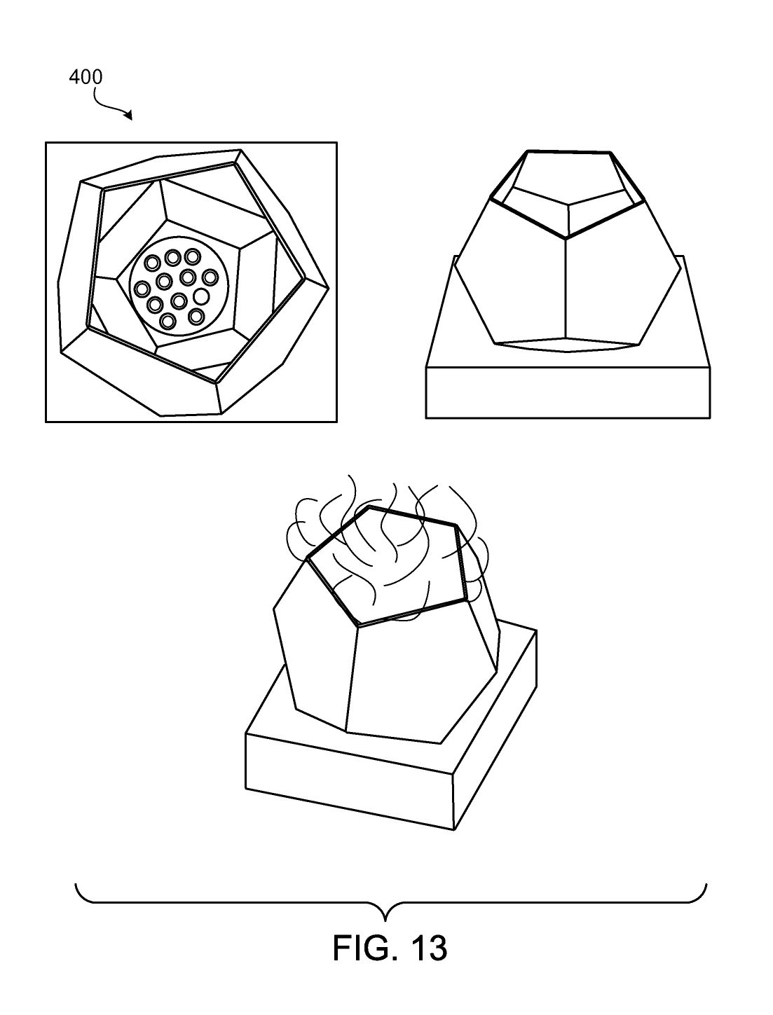

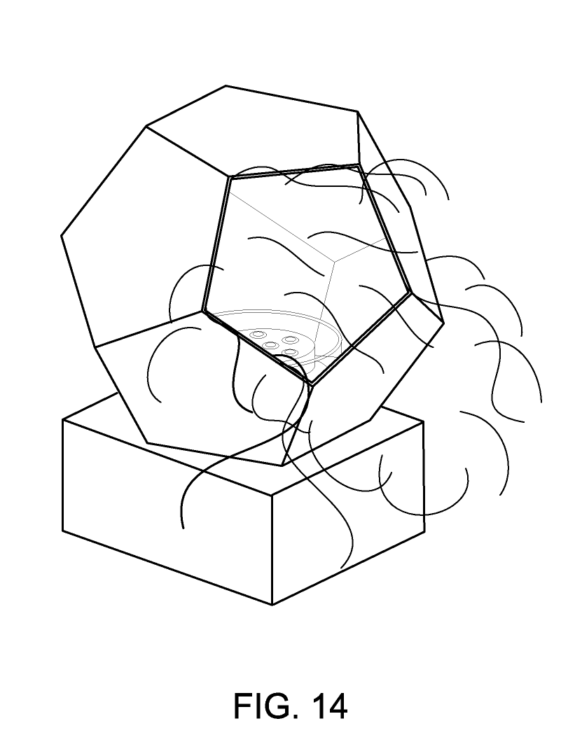

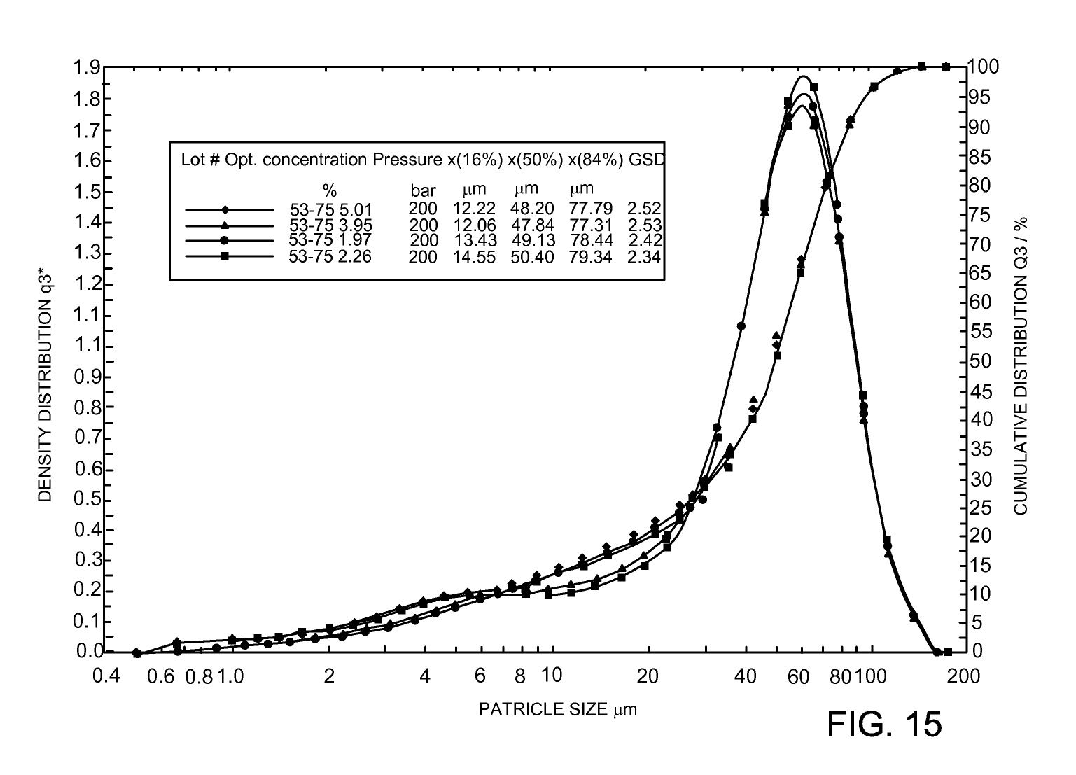

FIG. 15 shows the density distribution and cumulative distribution for four trials from the same sample. These data show that, for this particular sample, roughly 87% of the particles are larger than about 10 microns, and that roughly 79% of the particles are larger than about 20 microns. These findings demonstrate that a dehydrated food product (mint leaves) can be made into aerosolized particles substantially of a size (e.g. between at least 18 and 70 microns) that would typically deposit into the mouth upon inhalation.

In a sample of particles whose mean is approximately in this range, a small or negligible fraction of particles is able to enter into the throat and lungs and yet a considerable fraction of particles remains suspended for at least 5 seconds after a single inhaler actuation.

Clearly larger particle sizes could be aerosolized for at least as long with a larger aerosolization force or a more continued force of aerosolization, such as a continually or intermittently operating fan.

### Example 2

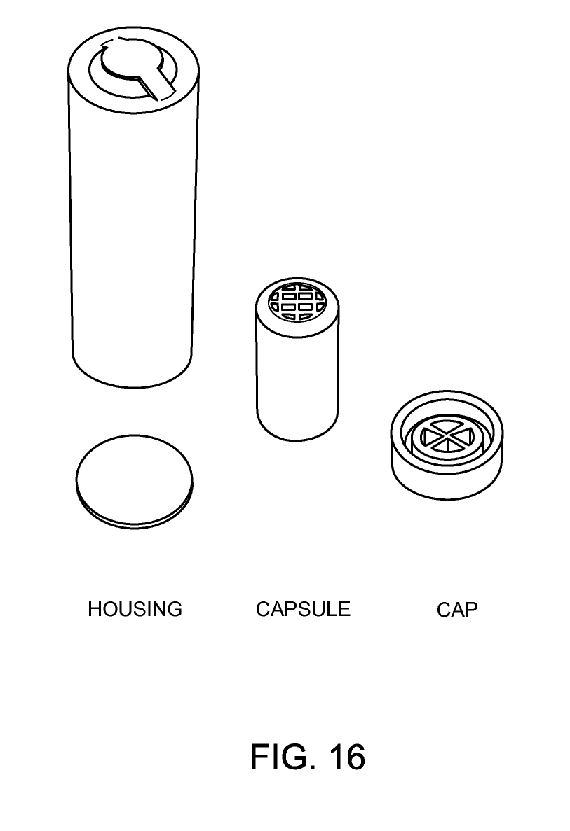

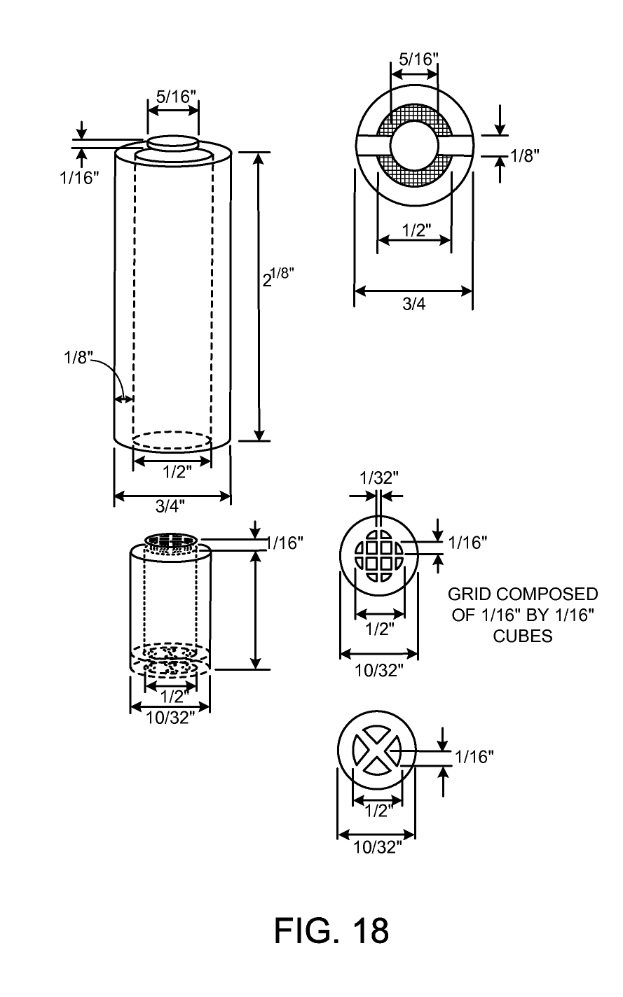

An aerosolized food delivery device as depicted in FIGS. 16-18 was designed so as to deliver aerosolized chocolate. Chocolate was chopped into fine particles, which was subsequently screened by size. It was found that many readily available chocolates, when ground, remain dry enough to aerosolize in the delivery device described so long as care is taken not to handle the particles excessively, which causes them to quickly melt and fuse. The dryness of commercially available chocolate or cocoa powders makes such powders useful in producing a different aerosol taste experience, while enabling the powders to be far more stable (e.g. far less prone to melting). Using sieves, particular size ranges can be selected, and it was found that (likely among other size ranges), samples with a large number of particles with diameters roughly in the range of 125-180 microns are appropriate for strong taste and aerosolizability. It was also found that certain particles, even though of a size that should fall out of the air before reaching the deeper respiratory system (>10 microns), can cause a coughing reflex, even when of sizes reaching on the order of 100 microns or larger, but this is noticeably reduced with the airflow-directing mouthpiece element. It was also found that the water-solubility of the particles might play a role in the likelihood of eliciting a coughing reflex, and that water-solubility likely affects the taste, mouth-feel, and other gustatory aspects of the experience. For example, in some cases, the flavor of highly-water soluble particles is preferred, because the flavor is more rapidly appreciated and/or has a greater impact. Particles substantially larger than 180 microns are increasingly difficult to aerosolize and begin to taste like small pieces of chocolate simply dropped onto the tongue.

To simplify the filling procedure, it was determined that standard size 3 and size 4 capsules contain amounts of the chocolate powder appropriate for a single-inhalation “dose”. A standard manual capsule filling machine can thus be used to prepare a large number of such doses for transfer to the powder compartment of the delivery device.

### Example 3

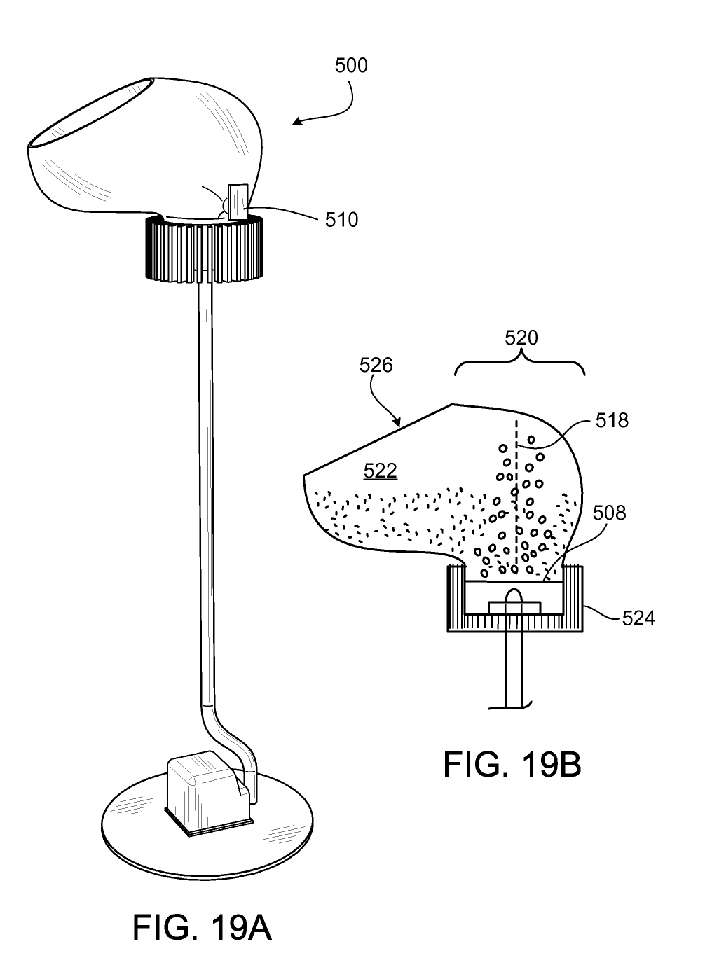

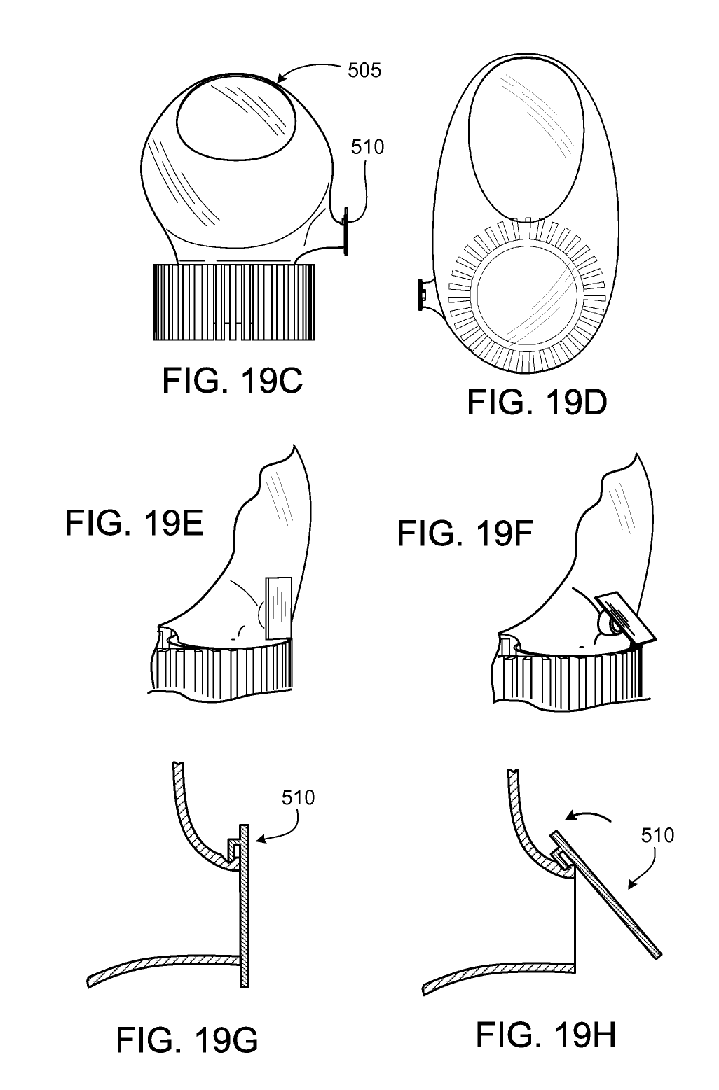

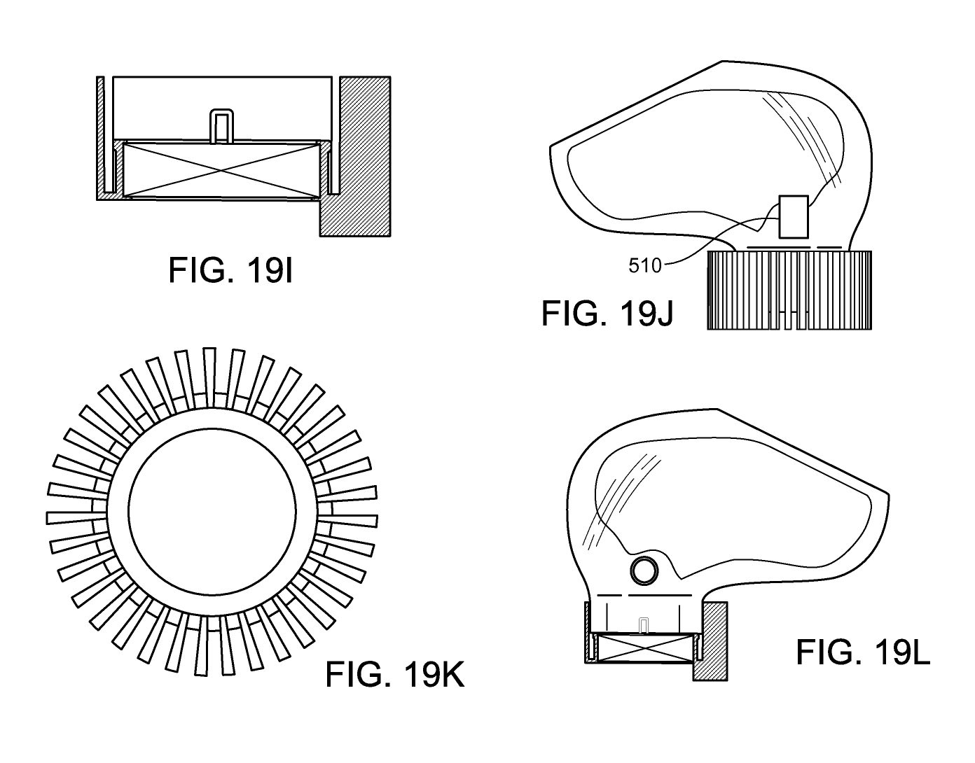

An aerosolized food delivery device 500 as depicted in FIGS. 19A and 19B was designed so as to deliver aerosolized beverages. Details of food delivery device 500 are shown in FIGS. 19C-19L.

As described above, aerosol clouds of edible substances can be made by ultrasonication of liquids. These clouds can be inhaled for ingestion, avoiding the respiratory tract, when particle sizes are sufficiently large and the cloud is inhaled.

However, use of piezo-electric crystals, for instance, which produce such clouds within liquids, can entail several drawbacks. First, the cloud produced tends to gather aerosol particles of a very wide size distribution. The very large particles tend to entrain the smaller particles and the character of the clouds can be unsuitable for inhalation and ingestion of edible substances. Particularly, these inhaled clouds tend to have relatively small amounts of aerosolized mass, and particle sizes best suited to mouth delivery, eg, 60-300 microns, are not in predominant proportions. Also this arrangement produces a cloud with splashing of the nature of a fountain.

We have discovered that ingestible aerosol clouds can be produced through ultrasonication and other means which avoid these problems and present many advantages to an inhaled eating experience. Food delivery devices 500 as shown in FIGS. 19A and 19B displace the aerosol cloud laterally relative to the source of the aerosol cloud such that large particles rise and fall over the source while smaller particles, particularly if lateral movement of cloud can occur very near to the surface 508 of the liquid, move by diffusion and convention laterally, escaping the falling large droplets.

The exemplary food delivery device includes an aerosol delivery device that discharges an aerosolized food product generally along a substantially vertical axis 518 (see e.g., FIG. 19B). Large and intermediate droplets that convect laterally fall by gravity, so if a lateral chamber exists that can contain the cloud, a cloud of fine aerosol particles exists which can be made to be a stable standing cloud. This cloud can be designed to possess particles in the desired mouth delivery range by manipulation of the dimensions of the cloud container and the properties of the liquid, including surface tension of the liquid. Notably, surface tensions lower than ˜72 dynes/cm can be achieved with the use of surfactants that produce excellent standing cloud aerosols.

In the exemplary food delivery device 500, a container attached to the aerosol delivery device defines a primary chamber 520 and a secondary chamber 522. The primary chamber 520 is hydraulically connected to the aerosol delivery device such that vertical axis 518 along which the delivery device discharges food particles extends into the primary chamber 520 and particles of at least a first size tend to rise and fall along the substantially vertical axis 518. The secondary chamber 522 is adjacent and open to the primary chamber 520. The secondary chamber 522 extends horizontally outward from the primary chamber 520 such that particles smaller than the first size tend to disperse from the primary chamber 520 into the secondary chamber 522.

The aerosol deliver device comprises a fluid reservoir with an ultrasonic generator. A free surface 508 of fluid in the fluid reservoir is exposed to the primary chamber 520 of the container. A lower surface of the secondary chamber 522 is angled such that liquid landing on the lower surface of the secondary chamber 522 tends to flow towards the fluid reservoir 524. Surfaces of the primary chamber include a surface extending across the substantially vertical axis 518 to limit travel of particles traveling along the substantially vertical axis 518.

The container defines an aperture extending through the container to the interior cavity. For example, the aperture 526 is vertically offset from the aerosol delivery device when the food delivery apparatus is positioned for operation. Thus, this container defines an aperture 526 opening into the secondary chamber 522 from above.

Further, an aperture or faucet 510 can be created whereby the cloud pours into glasses or other receptacles, a convenient and useful way of eating substances by inhalation. This aperture can be a closeable outlet 510 disposed in a lateral side surface of the container. The closeable side outlet 510 can include an aperture and a cap biased to close the aperture. In some cases, a resilient member placed to bias the cap to cover the aperture. In some cases, weight of the cap biases the cap to cover the aperture.

The apparatus is a tabletop or freestanding unit including a base configured to stably support the container on a supporting surface. For example, food delivery devices 500 can include/be mounted on stands as shown in FIGS. 19A and 19B. Food delivery devices 500 can also be placed directly on flat surfaces such as tables.

### Example 4

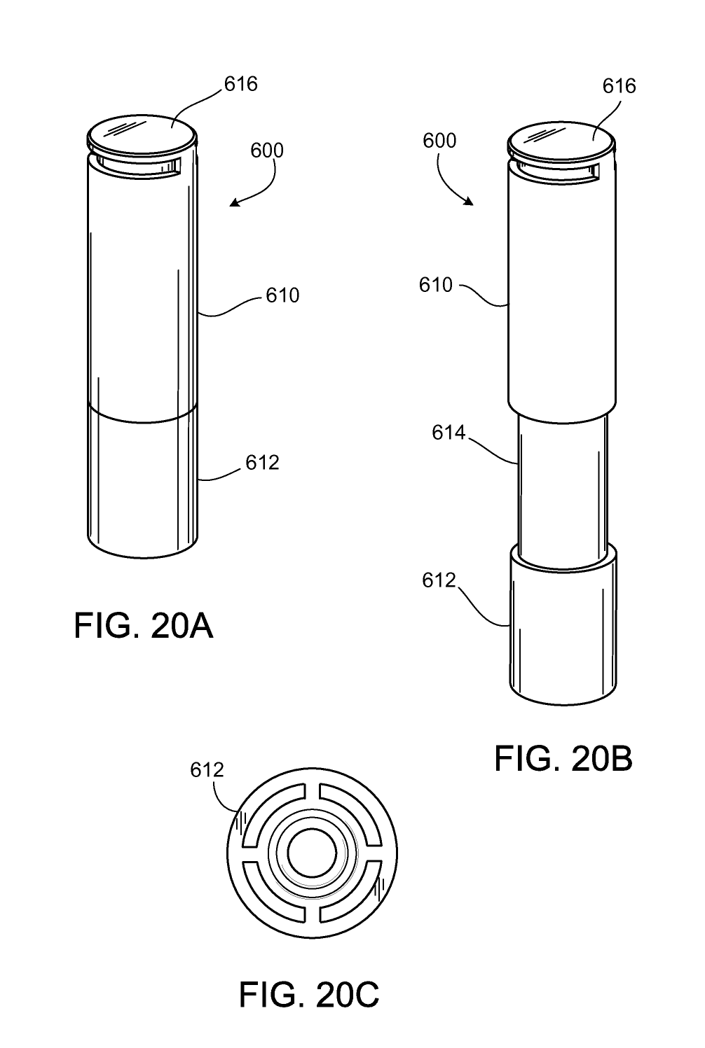

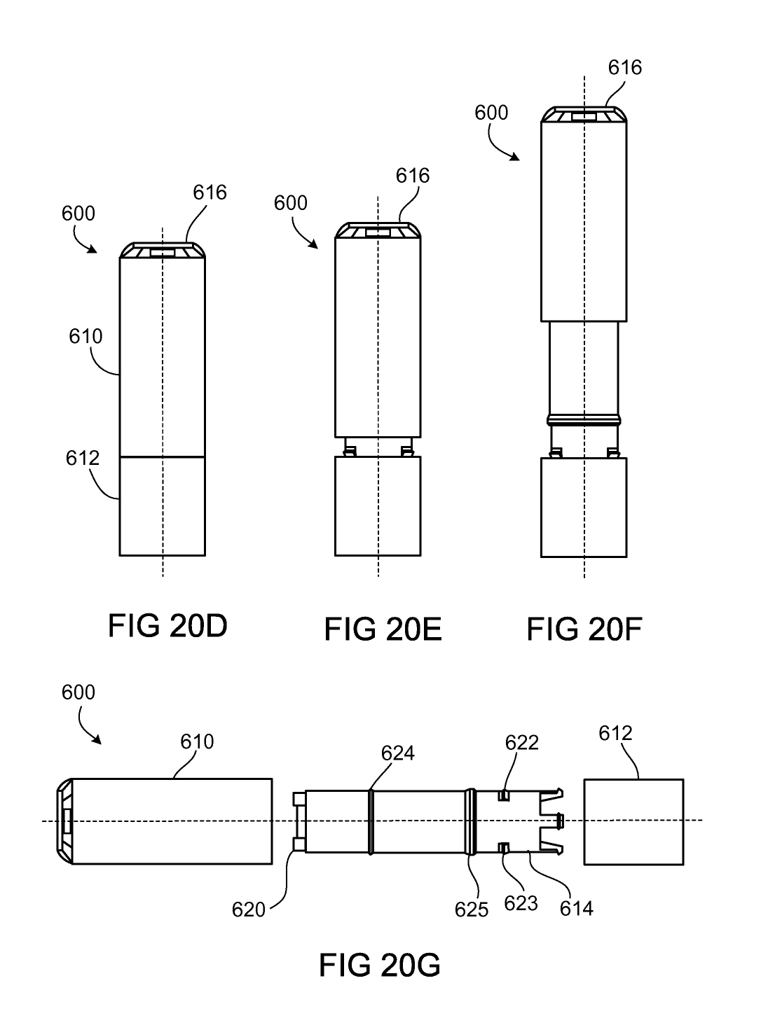

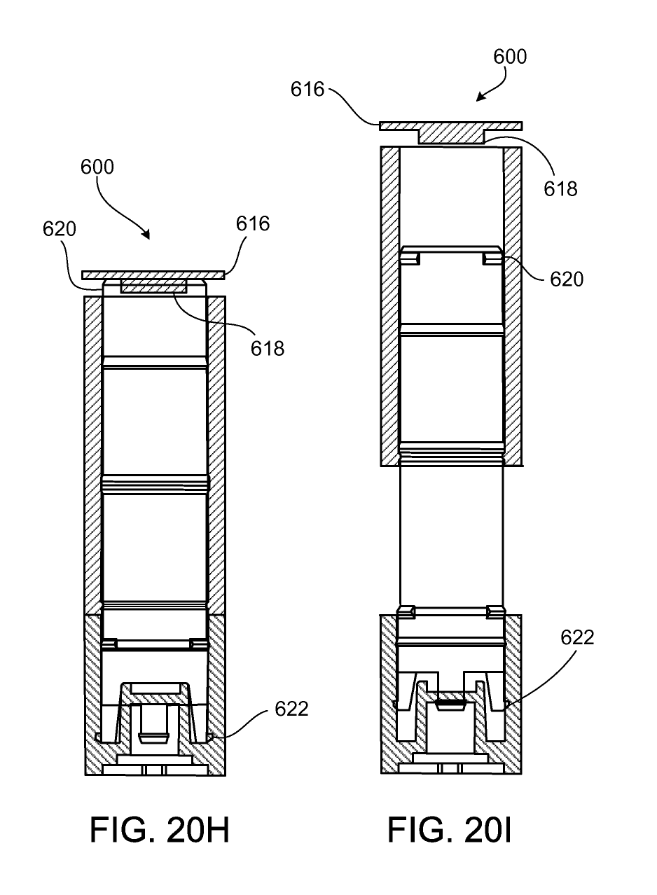

Another aerosolized food delivery device 600 as depicted in FIGS. 20A and 20B was also designed to deliver aerosolized food particles. Details of food delivery device 600 are shown in FIGS. 20C-20G.

The food delivery device 600 includes a mouthpiece 610, a cap 612, and a capsule 614 which can contain food particles. The food delivery device 600 differs from other embodiments (e.g., see FIGS. 2A-2G) in that the mouthpiece 610, the cap 612, and the capsule 614 have different relative overall lengths; disc sizes; and the contact between the capsule 614 and the mouthpiece 610, which allows the mouthpiece 610 to initially seal the top of the capsule 614. The mouthpiece 610 is shorter, and the capsule 614 is longer; the disc diameter is increased and equal to, or almost equal to, the mouthpiece outer diameter; and the capsule 614 is initially inside, and runs most or all of the length of the mouthpiece 610.

The mouthpiece 610 is generally cylindrical in shape. An additional cylinder 618 (see FIGS. 20H and 20I) below mouthpiece disc 616 and fits into the top of capsule 614 to seal a grating (not shown) through which aerosolized food particles are discharged when a user breathes in through the mouthpiece 610. The diameter of disc 616 is the same or nearly the same as the outer diameter of the mouthpiece 610. In one exemplary embodiment, the outer diameter of the mouthpiece 610 was 0.64 inches.

The capsule 614 is also generally cylindrical in shape. The end of the capsule 614 which is fitted into the mouthpiece 610 includes an annular ring 620 which extends axially outward from the rest of the capsule 614 (see FIGS. 20G-20I). The annular ring 620 is sized to fit around and engage the additional cylinder 618 under the mouthpiece disc 616, when the capsule 614 is fully inserted into the mouthpiece 610. The holes in the grating (not shown) atop the capsule 614 can thus be covered before activation of the device 600.

The capsule 614 includes snaps 622, 623 (see FIG. 20G-20I) at the bottom of the capsule 614 and allow the cap 612 to be either in an “open airflow” position (see FIGS. 20A, 20D, and 20 H) or “closed airflow” position (see FIGS. 20B, 20 F, and 20 I). The capsule 614 also includes snaps 624, 625 near the top of the capsule are similar to the other two, in that the snaps 624 allow the mouthpiece 610 to be in a lower “closed airflow” position (see FIGS. 20G-20I) and a higher “open airflow” position (see FIGS. 20A, 20D, and 20 H).

Closed position snaps 622, 625 need to be undone to activate device 600, and were designed to be weaker than open position snaps 623, 624 which need to be permanent (difficult to undo). In some embodiments, the closure strength of the pairs of snaps can be the same or the open position snaps can be weaker than the closed position snaps.

Before filling, the mouthpiece 610 and the capsule 614 are snapped together. The cylindrical feature 618 underneath the mouthpiece disc 616 and the annular ring 620 on the capsule 614 align to seal the top of the capsule 614, keeping the food particles being loaded inside the capsule 614. The combined capsule-mouthpiece unit is then filled. The capsule 614 is then closed at the opposite end by the addition of the cap 612. The closures protect the food particles from the environment, and limit airflow (e.g., with the three pieces in the “closed” position, airflow to/from the capsule 614 is largely blocked on both sides). The device can be offered to consumers in this configuration (see, e.g., FIG. 20D).

For activation, the cap 610 is pulled downward (allowing airflow from the bottom) and then held by a snap (see, e.g., FIG. 20E). The mouthpiece 610 is similarly pulled upward and then held by a snap, introducing space between the top of the capsule 614 and the mouthpiece disc 616, allowing airflow through the top (see, e.g., FIG. 20F). This is the “open” position, and the device 600 can now be used.

The entire device can be disposed of, or recycled, after use. In the exemplary device 600, the mouthpiece 610, capsule 614, and cap 612 are configured for permanent attachment after assembly.

1. A food delivery apparatus comprising:
an aerosol delivery device for discharge of an aerosolized food product generally along a substantially vertical axis;
a container attached to the aerosol delivery device, the container defining:
a primary chamber hydraulically connected to the aerosol delivery device such that vertical axis along which the delivery device discharges food particles extends into the primary chamber and particles of at least a first size tend to rise and fall along the substantially vertical axis; and
a secondary chamber adjacent and in communication with the primary chamber, the secondary chamber extending horizontally outward from and positioned relative to the primary chamber such that particles smaller than the first size tend to disperse from the primary chamber into the secondary chamber, the secondary chamber having an outlet spaced apart from the primary chamber.

2. The food delivery apparatus of claim 1, wherein the aerosol deliver device comprises a fluid reservoir with an ultrasonic generator.

3. The food delivery apparatus of claim 2, wherein a free surface of fluid in the fluid reservoir is exposed to the primary chamber of the container.

4. The food delivery apparatus of claim 2, wherein a lower surface of the secondary chamber is angled such that liquid landing on the lower surface of the secondary chamber tends to flow towards the fluid reservoir.

5. The food delivery apparatus of claim 1, wherein surfaces defining the primary chamber include a surface extending across the substantially vertical axis to limit travel of particles traveling along the substantially vertical axis.

6. The food delivery apparatus of claim 1, wherein the apparatus is a tabletop or freestanding unit including a base configured to stably support the container on a supporting surface.

7. The food delivery apparatus of claim 1, wherein the container defines an aperture extending through the container to the interior cavity, the aperture vertically offset from the aerosol delivery device when the food delivery apparatus is positioned for operation.

8. The food delivery apparatus of claim 1, wherein the container defines an aperture opening into the secondary chamber from above.

9. The food delivery apparatus of claim 1, wherein the container comprises a closeable outlet disposed in a lateral side surface of the container.

10. The food delivery apparatus of claim 9, wherein the closeable side outlet comprises an aperture and a cap biased to close the aperture.

11. The food delivery apparatus of claim 10, comprising a resilient member placed to bias the cap to cover the aperture.

12. The food delivery apparatus of claim 10, wherein weight of the cap biases the cap to cover the aperture.

13. A food delivery apparatus comprising:
an aerosol delivery device for discharge of aerosolized food product; the aerosol delivery device including:
a mouthpiece defining a first fluid flow passage extending between a mouthpiece inlet and a mouthpiece outlet;
a deflection member spaced apart from a plane of the mouthpiece outlet, the deflection member positioned to oppose flow of aerosolized food product along an axis of the mouthpiece outlet;
a capsule containing an aerosolizable food product, the capsule defining a second fluid flow passage extending between a capsule inlet and a capsule outlet, the capsule attached to the mouthpiece such that, in a first position of the mouthpiece, the mouthpiece substantially seals the capsule outlet, and, in a second position of the mouthpiece, the capsule outlet is fluidly connected to the mouthpiece inlet; and
an end cap defining at least one air intake passage extending through the end cap, the end cap attached to the capsule such that, in a first position of the end cap, the end cap substantially seals the capsule inlet, and, in a second position of the end cap, the capsule inlet is fluidly connected to the air intake passage of the end cap.

14. The food delivery apparatus of claim 13, wherein the capsule comprises an aerosol generating device.

15. The food delivery apparatus of claim 14, wherein the aerosol generating device comprises a grating.

16. The food delivery apparatus of claim 13, wherein the capsule is configured to be replaceable.

17. The food delivery apparatus of claim 13, wherein the apparatus is configured to provide permanent attachment of the end cap and the mouthpiece to the capsule.

18. The food delivery apparatus of claim 13, wherein the apparatus is handheld.

19. A replaceable capsule containing an aerosolizable food product for use in a food delivery apparatus of claim 13.
